(19) United States
(12) Patent Application Publication
(10) Pub. No.: US 2022/0048478 A1
(43) Pub. Date: Feb. 17, 2022

(54) AUTOMATED VEHICLE WASHING SYSTEM AND/OR METHOD

(71) Applicant: Plover, Inc., Miwaukie, OR (US)

(72) Inventors: Michael McGovern, Milwaukie, OR (US); Victor Wang, Milwaukie, OR (US); Nathan Fuller, Milwaukie, OR (US); Max Tag, Milwaukie, OR (US)

(21) Appl. No.: 17/404,167

(22) Filed: Aug. 17, 2021

Related U.S. Application Data
(60) Provisional application No. 63/066,720, filed on Aug. 17, 2020.
(60) Provisional application No. 63/067,167, filed on Aug. 18, 2020.

(51) Int. Cl. B60S 3/04; B05B 12/16; B05B 15/70; G06T 17/20

(52) U.S. Cl. CPC B60S 3/04; B05B 12/16; H04N 5/23299; G06T 17/20; B05B 15/70

(57) ABSTRACT

The method can include: sampling measurements of a vehicle in-situ, generating a model based on the measurements, and determining a wash path based on the model. The method can optionally include washing the vehicle according to the wash path.

### CROSS REFERENCE TO RELATED APPLICATIONS

This application claims the benefit of U.S. Provisional Application No. 63/067,167, filed 18 Aug. 2020, which is incorporated herein in its entirety by this reference.

This application claims the benefit of U.S. Provisional Application No. 63/066,720, filed 17 Aug. 2020, which is incorporated herein in its entirety by this reference.

### TECHNICAL FIELD

This invention relates generally to the vehicle washing field, and more specifically to a new and useful automated car wash path planning method in the vehicle washing field.

### BRIEF DESCRIPTION OF THE FIGURES

FIG. 1 is a diagrammatic representation of a variant of the automated car wash path planning method.

FIG. 2A is a schematic representation of a variant of the automated car wash path planning method from a top view.

FIG. 2B and 2C are schematic representations of a first and second variant of the automated car wash path planning method, respectively, each from a front view.

FIG. 3A and 3B are schematic representations of a first and second variant of the method, respectively, each from a top view.

FIG. 4 is a schematic representation of an orientation of the tool head in a variant of the method.

FIG. 5 is a schematic representation of a variant of the vehicle washing system.

FIG. 6A is an example of wash path generation in a variant of the method from a top view.

FIG. 6B is an example of wash path generation in a variant of the method from a top view.

FIG. 6C is an example of wash path generation in a variant of the method from a top view.

FIG. 7 is a variant of a vehicle model in a variant of the method.

FIG. 8 is a specific example of a variant of the method.

FIG. 9 is a schematic representation of a variant of the vehicle washing system.

FIG. 10A-D are side views of a first, second, third, and fourth example of the model, respectively.

FIG. 11A-B are first and second schematic examples of an embodiment of convex hull generation.

FIG. 12A is a diagrammatic representation of a top wash variant of the method.

FIG. 12B is a diagrammatic representation of a top wash variant of the method.

FIG. 13 is a diagrammatic representation of a side wash variant of the method.

FIG. 14 is a schematic representation of a variant of the vehicle washing system.

FIG. 15 is a schematic representation of a variant of a tool head of the vehicle washing system.

FIG. 16A-C are schematic representations of first, second, and third variants of the vehicle washing system in top wash, side wash, and self-wash configurations, respectively.

FIG. 17A is a schematic representation of an example tool head in a variant of the vehicle washing system.

FIG. 17B is a dimetric view of an example tool head in a variant of the vehicle washing system.

FIG. 18A-B are schematic representations of a first and second example cable/hose management in a variant of the vehicle washing system in extended and retracted configurations, respectively.

FIG. 19 is an isometric view of a variant of a tool head.

FIG. 20 is an isometric view of a variant of a tool head.

FIG. 21 is an isometric view of a variant of a tool head.

FIG. 22 is an isometric view of a variant of a multi-stage Z-axis.

FIG. 23 is an isometric view of a variant of a multi-stage Z-axis.

FIG. 24A and 24B are an isometric view and side view of a variant of the vehicle washing system.

FIG. 25 is a schematic representation illustrating the working volume in a variant of the vehicle washing system.

FIG. 26 is a schematic representation illustrating an arrangement of a pair of imaging sensors relative to a working volume in a variant of the vehicle washing system.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

### 1. Overview.

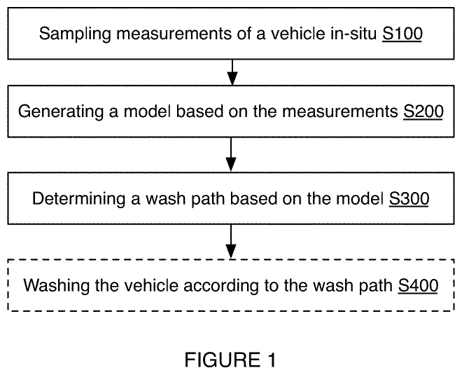

The method, as shown in FIG. 1 can include: sampling measurements of a vehicle in-situ S100, generating a model based on the measurements S200, and determining a wash path based on the model S300. The method can optionally include washing the vehicle according to the wash path S400. However, the method can additionally or alternatively include any other suitable elements. The method functions to determine control for a wash tool head to wash an in-situ vehicle. The method can additionally function to improve wash efficiency of automated vehicle washing systems by automatically determining a wash path that traces the peripheral shape of the vehicle, which can reduce wash time and fluid waste.

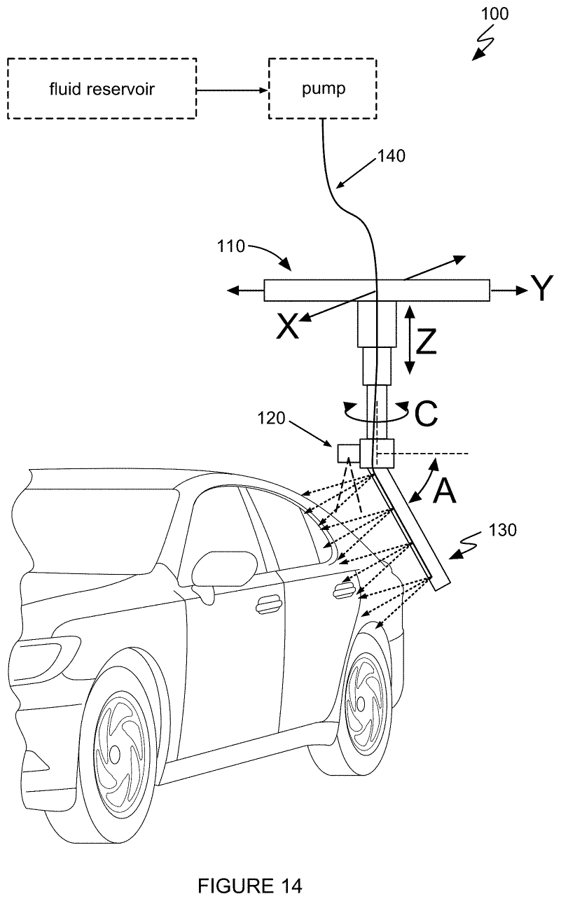

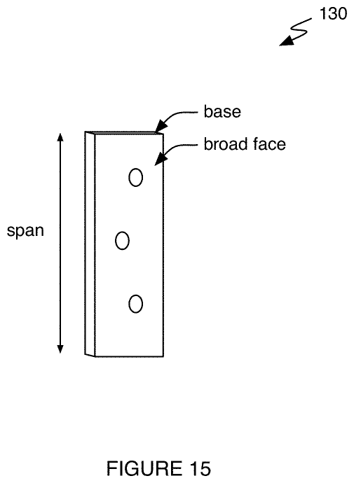

The vehicle washing system 100, an example of which is shown in FIG. 14, can include: a plurality of actuation mechanisms 110, an imaging system 120, a tool head 130, and a fluid manifold 140. The vehicle washing system functions to clean an in-situ vehicle arranged within an extent of the vehicle washing system. The vehicle washing system can additionally function to direct a fluid according to a wash path. The vehicle washing system can optionally include a pump, a heater, and a fluid reservoir. However, the vehicle washing system 100 can additionally or alternatively include any other suitable set of components.

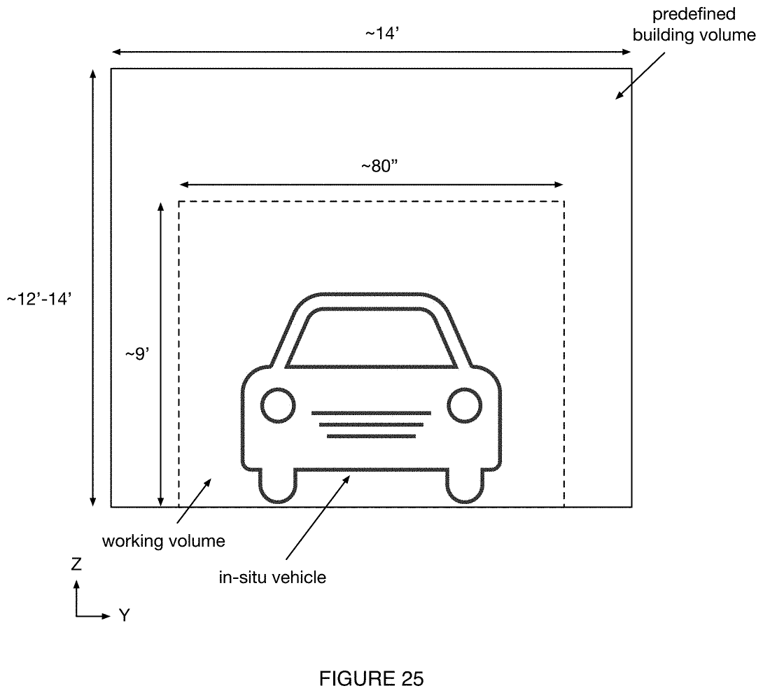

The vehicle washing system can be configured to interface with a building or other structure of a predefined building volume and an in-situ vehicle arranged therein. The actuation mechanisms of the vehicle washing system can cooperatively define a working volume (or maximally sized vehicle geometry which can be accommodated) within the predefined building volume. The vehicle washing system can engage a frame or other infrastructure within the predefined building volume (and outside of the working volume) and/or can include such structural members (e.g., I-beams, etc.). In variants, the vehicle washing system can be retrofitted into an existing structure—such as a manual or pre-existing automatic car wash—and can be configured to operate within the boundaries thereof. In a specific example, the vehicle washing system can be configured to operate in a predefined building volume with a vertical dimension of between 12 and 14 feet and a lateral dimension of about 14 feet. In a second specific example, the vehicle washing system can be configured to accommodate wide consumer vehicles—such as a dually truck (e.g., ˜79.4″ rear axle width)—with a lateral dimension of the predefined build volume of about 14 feet. In a third specific example, the vehicle washing system can accommodate a vehicle height of approximately 9 feet with a structure height of about 12 feet. A specific example of the working volume relative to a predefined build volume is shown in FIG. 25.

### 2. System Examples.

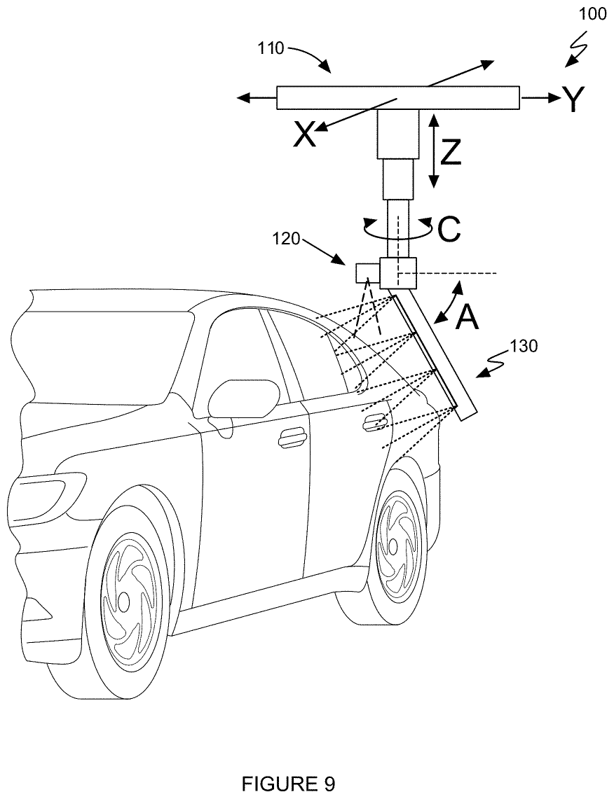

In variants, a vehicle washing system can include: a gantry system, wash tool head, and an imaging system. The vehicle washing system preferably functions to control the wash tool head according to the wash path. However, the vehicle washing system 100 can additionally or alternatively include any other suitable set of components. A first example of the vehicle washing system 100 is shown in FIG. 9.

The vehicle washing system can include a gantry system, which functions to manipulate the pose of the wash tool head. The gantry system can include any suitable degrees of freedom and/or control axes. The gantry system is preferably a 5-axis system, but can alternately be 4.5 axis, 4 axis, 3 axis, and/or include any other suitable number of axes and/or degrees of freedom. In a specific example, the gantry system can include an X-axis, which is preferably substantially aligned with a longitudinal axis of the vehicle and can translate the tool head longitudinally relative to the vehicle (e.g., along a long axis of the vehicle). In a second example, the gantry system can include a Y-axis, which is preferably substantially aligned with a lateral axis of the vehicle (e.g., width of the vehicle) and can translate the tool head laterally relative to the vehicle. In a third example, the gantry system can include a Z-axis, which is preferably substantially aligned with a vertical axis of the vehicle and/or gravity vector and can translate the tool head vertically. In a fourth example, the gantry system can include a C-axis which can rotate the tool head about the Z-axis (or azimuthally relative to an X-Y plane cooperatively defined by the X and Y axes). In a fifth example, the gantry system can include an A-axis which can rotate the tool head elevation angle relative to an X-Y plane (e.g., which may be positive or negative).

The gantry system can include any suitable ranges of motion in any degree of freedom. Ranges of motion which can be the same or different for each translational and/or rotational degree of freedom. In a specific example, the A-axis has a range of motion of −10 degrees to +100 degrees relative to a vertical direction (with positive defined in the direction of the spray). In a second specific example, the C axis has a range of motion of −270 degrees to +270 degrees. In a second specific example, the C axis has a range of motion of +3 rotations, −3 rotations. In a third specific example, the C axis has an unconstrained range of motion. However, each axis and/or degree of freedom of the gantry system can include any suitable range of motion.

The one or more axes of the gantry system can individually and/or cooperatively define a working volume according to the range of motion. In a specific example, the working volume can be 9 ft vertically, 14 feet laterally, and at least 20 feet longitudinally. However, the vehicle washing system can include any other gantry system and/or other suitable actuatable mechanism(s).

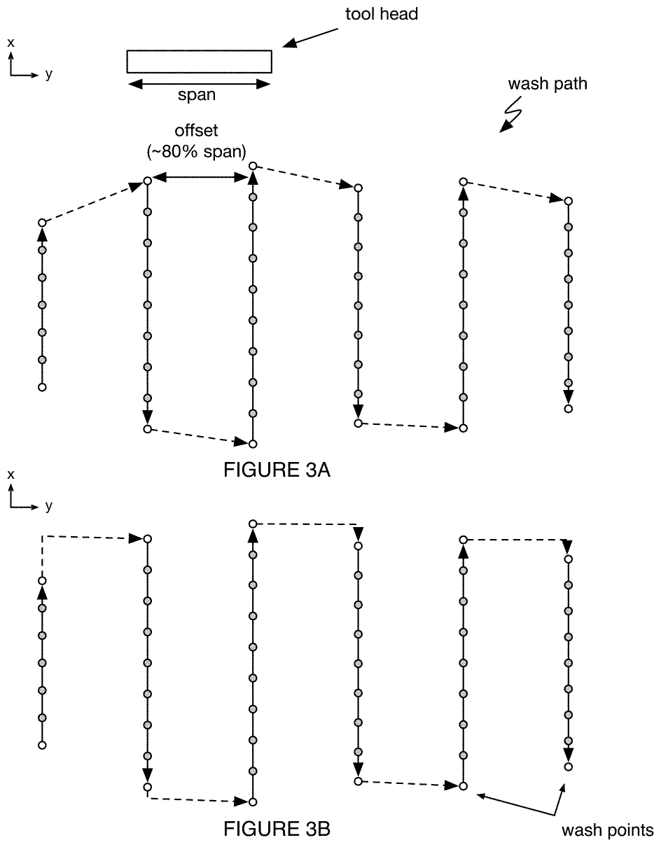

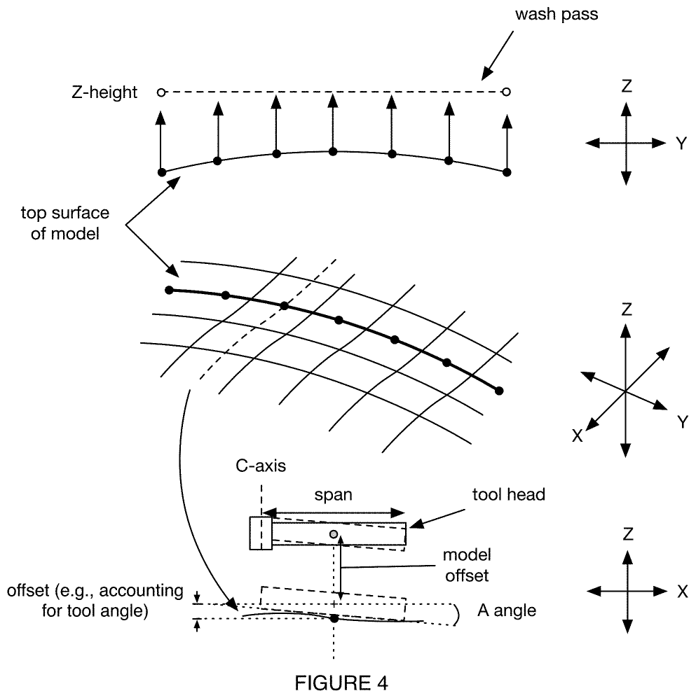

The vehicle washing system can include a wash tool head, which functions to spray a (pressurized) fluid to wash the vehicle. Preferably the wash tool head defines a span (or characteristic length) in its largest dimension but can define any suitable set of dimensions. Examples of the span are shown in FIGS. 3A and 4. In a specific variant, a cone angle of the fluid nozzles and a distance between fluid nozzles can cooperatively define an optimal offset/spacing range between the wash tool head and the vehicle surface (e.g., where spray cones do not overlap). In a specific example the optimal spacing can be about 6″-8″. However, the optimal offset can be otherwise defined.

The wash tool head is preferably actuatable along an X-axis, Y-axis, Z-axis, rotatable about an A-axis (e.g., pitch relative to the wash tool head mounting point), and rotatable about a C-axis (e.g., yaw relative to the wash tool head mounting point), but can be otherwise articulable. In a specific example, the A-axis has a range of motion of −10 degrees to +100 degrees relative to a vertical direction (with positive defined in the direction of the spray), and/or the C axis has a range of motion of −270 degrees to +270 degrees. However, the A and C axes can have other ranges of motion. The wash tool head is preferably mounted to and actuated by a gantry system, but can be otherwise mounted and/or controlled. In a specific example, the coordinate frame of the wash system is defined at a center point of the broad face of the wash tool head. Alternately, the coordinate frame of the wash head is defined at a base of the wash tool head, and/or otherwise suitably defined. However, the vehicle washing system can include any other suitable wash tool head.

The vehicle washing system can include an imaging system which functions to sample measurements of the in-situ vehicle to determine a model for wash path planning. The measurements (or resultant data) preferably include: points within a point cloud (e.g., scaled, unsealed, labeled, etc.), but can additionally or alternatively include images (e.g., RGB images) or other datum. The imaging system is preferably mounted to the wash tool head, but can be mounted to the carwash bay, gantry, or other surface. The imaging system can include one or more sensors. The sensors can be arranged with a downward-facing field of view (FOV), sideways FOV, and/or otherwise arranged. The sensors can include: a lidar system, camera system (e.g., monocular, stereoscopic, etc.), time of flight sensors, accelerometers, and/or other sensors. In a specific example, the Lidar includes a 20 degree field of view in a downward facing direction (e.g., can have a 360 degree puck with a +/−10 degree width), but can include any other suitable sensing range. However, the system can include any other suitable imaging system which can be otherwise suitably configured.

However, the vehicle washing system can include any other suitable set of components which can otherwise suitable control the wash tool head according to the wash path.

### 3. Benefits.

Variations of the technology can afford several benefits and/or advantages.

First, variations of this technology can improve wash coverage and/or efficacy of automated vehicle washing systems by optimizing a spray distance (offset) and/or angle between a wash tool head and an exterior surface of a vehicle. Further, such variants can improve wash coverage of surfaces adjacent to peripheral vehicle features (e.g., spoilers, wings, wing mirrors, antennae, etc.), which can otherwise disrupt spray patterns. In variants, the technology can further enable uniform coverage across a sagittal (longitudinal) plane of an in-situ vehicle, even if the in-situ vehicle is displaced or angled relative to a (longitudinal) centerline of the vehicle washing system. Such variations can adjust the wash pattern according to a location, orientation, and/or specific shape of the vehicle determined from an initial scan—thereby improving the wash coverage. However, variations of the technology can otherwise improve wash coverage.

Second, variations of the technology can improve wash efficiency of automated vehicle washing systems by automatically determining a wash path that traces the peripheral shape of the vehicle, which can reduce wash time and fluid waste. Accordingly, such systems can minimize the number of wash paths, wash passes, and/or rotations of the tool head and thereby prevent the system from repeatedly washing the same sections of the vehicle exterior and/or directing water spray away of the vehicle (e.g., common in open-loop automated wash systems). However, variations of the technology can otherwise improve wash efficiency.

Third, variations of this technology can provide decreased packaging volume for automated vehicle washing systems and/or CNC axes, which can enable variations of the system to fit within predefined vertical and/or lateral dimensions. In variants, this can enable the vehicle washing system to be retrofitted into existing infrastructure—such as existing car washes. In particular, a multi-stage Z axis (e.g., telescopic Z-axis) can enable the vehicle washing system to operate in structures with limited ceiling heights (e.g., <12 feet), while still maintaining a working volume which can accommodate consumer vehicles (e.g., 9 foot vertical working volume). Further, variations can minimize a lateral breadth cooperatively defined by the tool head and rotational axes in the ‘side wash’ configuration, which can enable the vehicle washing system to accommodate wide consumer vehicles—such as a dually truck (e.g., ˜79.4″ rear axle width). However, variations of the vehicle washing system can otherwise provide decreased packaging volume and/or otherwise accommodate any suitable set of vehicles

Fourth, variations of this technology can provide improved spray coverage since multi-axis actuation can allow the tool head to more closely conform to the exterior geometry of an in-situ vehicle. This can enable improved cleaning and/or minimize waste of cleaning fluids—reducing both the time and cost associated with overspray and/or extraneous spray. Additionally, variations can improve the wash coverage by increasing the spanwise density of spray nozzles along the tool head. By offsetting/staggering nozzles in a secondary dimension of the tool head, the spanwise density of nozzles can be increased without increasing spray interference. However, variations of the vehicle washing system can otherwise provide improved spray coverage.

Fifth, variations of the technology can include non-backdrivable components and/or braking features which can prevent power loss and/or component failure from ‘dropping’ the tool head in a particular axis (which could result in property damage to the in-situ vehicle). Further, variations of the technology can decouple powered actuators and/or limit the force/torque exerted by actuators in the event of contact with a vehicle or a force/torque in excess of a threshold—which can avoid damage to both the vehicle and the vehicle washing system. However, variations of the vehicle washing system can otherwise provide increased safety.

Sixth, variations of the technology can provide improved serviceability and/or minimize maintenance costs by utilizing various self-lubricating components and components resilient to various environmental conditions. Additionally, variations of the technology can eliminate components which exhibit wear characteristics (e.g., by directly contacting a vehicle) and/or need to be frequently serviced or replaced. Accordingly, such variations of the technology can decrease the frequency of maintenance from an interval of service every several weeks to an interval of a year or more. However, variations of the vehicle washing system can otherwise provide increased serviceability and/or otherwise decrease maintenance costs.

However, variations of the technology can additionally or alternately provide any other suitable benefits and/or advantages.

### 4. System.

The vehicle washing system 100 can include: a plurality of actuation mechanisms 110, an imaging system 120, a tool head 130, and a fluid manifold 140. The system functions to clean an in-situ vehicle arranged within an extent of the vehicle washing system. The system can additionally function to direct a fluid according to a wash path. The system can optionally include a pump, a heater, and a fluid reservoir. However, the system 100 can additionally or alternatively include any other suitable set of components. A first example of the system 100 is shown in FIG. 1. The vehicle washing system is preferably a computer numerically controlled (CNC) vehicle washing system, but can be otherwise controlled.

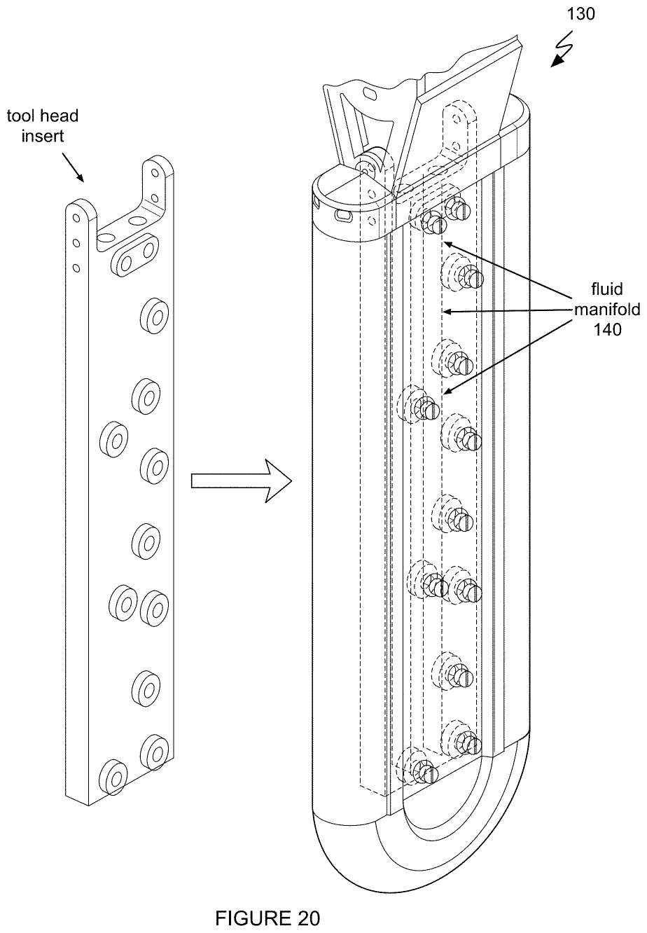

The tool head functions to perform a cleaning operation. Additionally or alternately, the tool head can function to direct a fluid toward an in-situ vehicle arranged within an extent of the vehicle washing system. The tool head can include a unitary component (e.g., unitary body) and/or a plurality of components forming an assembly—such as a tool head insert mounted to a ‘paddle’ structure (an example is shown in FIG. 20). The tool head can be formed from and/or include any suitable set of materials, such as metal (e.g., aluminum, stainless steel) or plastic (e.g., thermoplastic). The tool head can be manufactured using any suitable technique (e.g., 3D printing, SLS, injection molded, etc.). The tool head preferably includes a set of spray nozzles (e.g., for liquid, gas, steam, air, etc.), but can alternatively include a rotating brush head, or other tool type.

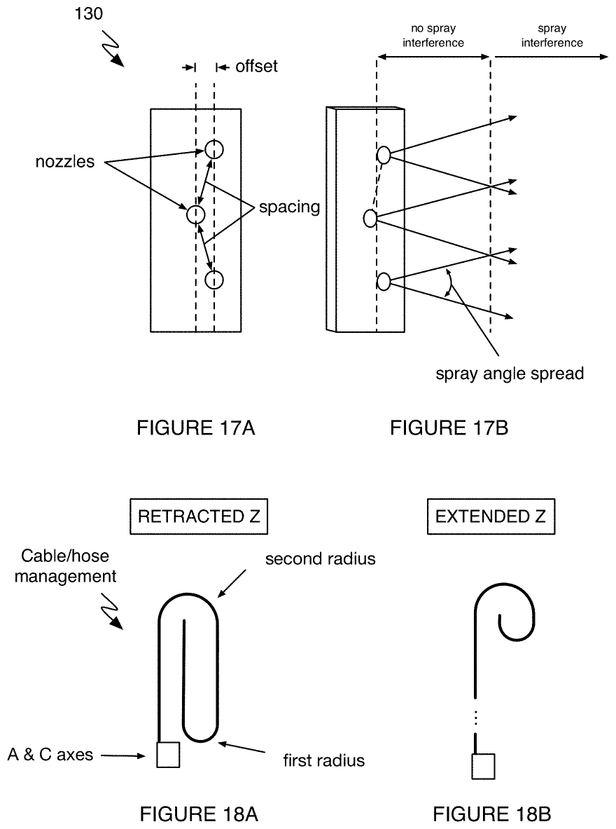

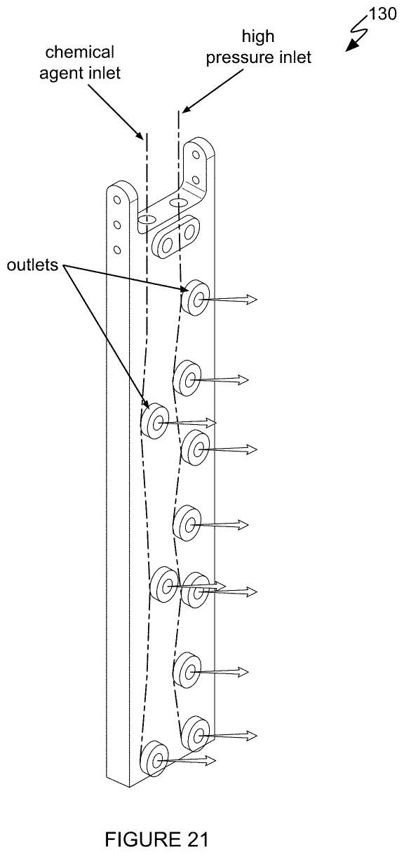

The tool head can include a set of nozzles, which function to disperse a fluid according to a cleaning operation. Each nozzle is preferably in fluid communication with the fluid manifold and/or connected to the fluid manifold in any suitable arrangement. Nozzles can be arranged in any suitable combination and/or permutation of series and/or parallel. In a specific variant, a first array of fluid nozzles is coupled to a first fluid line (e.g., chemical line, low pressure line, high temperature line, etc.) and a second array of fluid nozzles is coupled to a second fluid line (e.g., high pressure), such as in the example shown in FIG. 21. In a second specific variant, a single fluid line supplies each of the nozzles on the tool head. Nozzles (within a single array and/or across multiple arrays) can be aligned, arranged in linear arrays, misaligned (e.g., such as a zig-zag pattern, staggered, etc.), and/or have any other suitable geometry. Arrays of nozzles can be aligned with and/or offset relative to a spanwise direction of the tool head, but can be otherwise arranged. Nozzles within an array preferably define a uniform nozzle spacing, but can alternately be unevenly spaced and/or otherwise suitably arranged. The nozzle spacing can correspond to an interference distance (calculated trigonometrically by the angle of the spray cone of adjacent nozzles), such that the fluid dispersed/sprayed by the nozzles will not interfere before contacting the vehicle. In a specific example, the wash head operates at a nominal distance of 6-8 inches from the vehicle, where the interference distance is >8 inches (e.g., 10 inches). An example of the nozzle spacing is shown in FIG. 17A and a corresponding example of spray interference is shown in FIG. 17B. However, the nozzles can be otherwise suitably arranged.

The tool head can include any suitable geometry and/or features. Preferably, the tool is ‘paddle’ shaped such that it defines a broad face with a longitudinal axis substantially longer than a lateral axis (e.g., more than 1× or 2× the lateral axis), but can include any suitable profile shape, cross section shape, and/or other geometry. The tool head can define any suitable spanwise dimension (e.g., extending along its largest dimension, length orthogonal to both the A-axis and C-axis). In a specific example, the span can be approximately 2 feet. In a second specific example, the span is approximately ⅓ the height of a vehicle (e.g., such that 3 side wash passes can provide full coverage of the sides of a sedan or other vehicle). The tool head can define any suitable width dimension on a broad face and any suitable thickness (orthogonal to the broad face). In a specific variant, the width can be determined based on (e.g., is strictly greater than) an offset of a first and second array of nozzles and/or a width offset between adjacent nozzles within an array of nozzles (an example is shown in FIG. 17A. The thickness of the tool head is preferably greater than a diameter of the fluid manifold, but can be otherwise suitably determined.

An interior of the tool head can form a portion of the fluid manifold, fluidly connecting an inlet to an array of nozzles at an array of corresponding outlets. Inlets and outlets can define parallel central axes, orthogonal central axes, collinear central axes (A common central axis), and/or be otherwise arranged. In a specific example, a tool head insert can fluidly connect each nozzle to a portion of the fluid manifold. In a second specific example, the tool head insert can include two parallel fluid pathways (e.g., defining geometrically parallel axes and/or fluidically parallel), coupling a first inlet to a first set of outlets and a second inlet to a second set of outlets. Alternately, each of the fluid nozzles can be connected via a separate tube and/or the fluid manifold can extend peripherally relative to the tool head. However, the nozzles can be otherwise suitably connected to the fluid manifold.

However, the tool head can include any other suitable set of components and/or otherwise suitably perform a cleaning operation and/or disperse fluid.

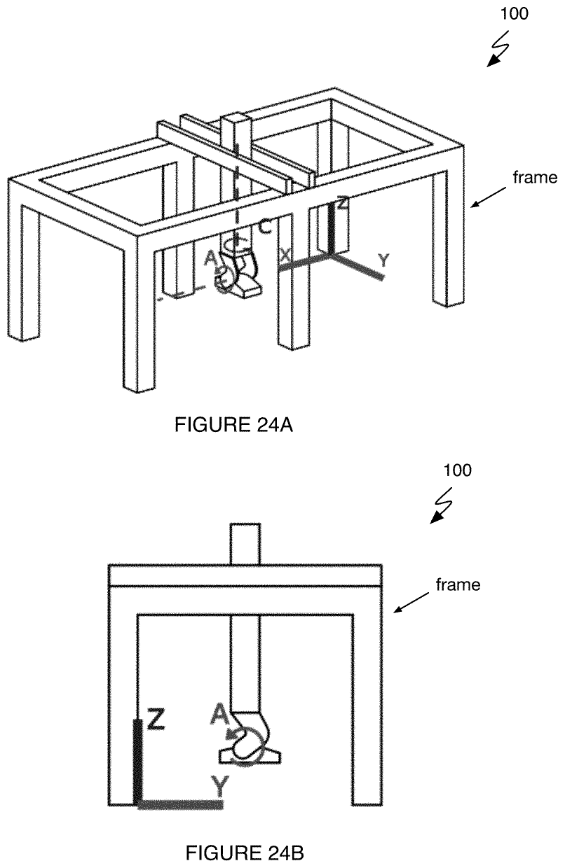

The actuation mechanisms function to manipulate the tool head about a plurality of axes (or degrees of freedom). The plurality of actuation mechanisms can include translational actuation mechanisms, configured to change the position of a tool head along the associated axis, and rotational actuation mechanisms, configured to rotate the tool head about the associated axis. There can be any suitable number of actuation mechanisms and/or define any suitable number of degrees of actuator freedom. Preferably, the vehicle washing system includes 5 degrees of actuator freedom (e.g., includes 5 actuation mechanism forming a 5-axis system), but can alternately define more than five degrees of freedom, less than 5, and/or be otherwise suitably configured. Preferably, each degree of freedom (or axis/actuator) is coupled to the tool head such that the vehicle remains static in-situ during wash operation—however the actuation mechanisms can be otherwise suitably configured. In variants, the plurality of actuation mechanisms can include three translational actuation mechanisms, with one translational actuation mechanism tied to each of the X-axis (extending in a longitudinal direction), the Y-axis (extending in a lateral direction), and the Z-axis (extending in a vertical direction). In a specific example, the actuation mechanism of the X, Y, and/or Z axes can include a gantry system. In variants, the plurality of actuation mechanisms can include two rotational actuation mechanisms, with one translational actuation mechanism tied to each of the C-axis (rotating about the Z-axis), A-axis (e.g., rotating about the Y-axis). Specific examples of the X, Y, Z, C, and A axes are shown in FIGS. 24A and 24B.

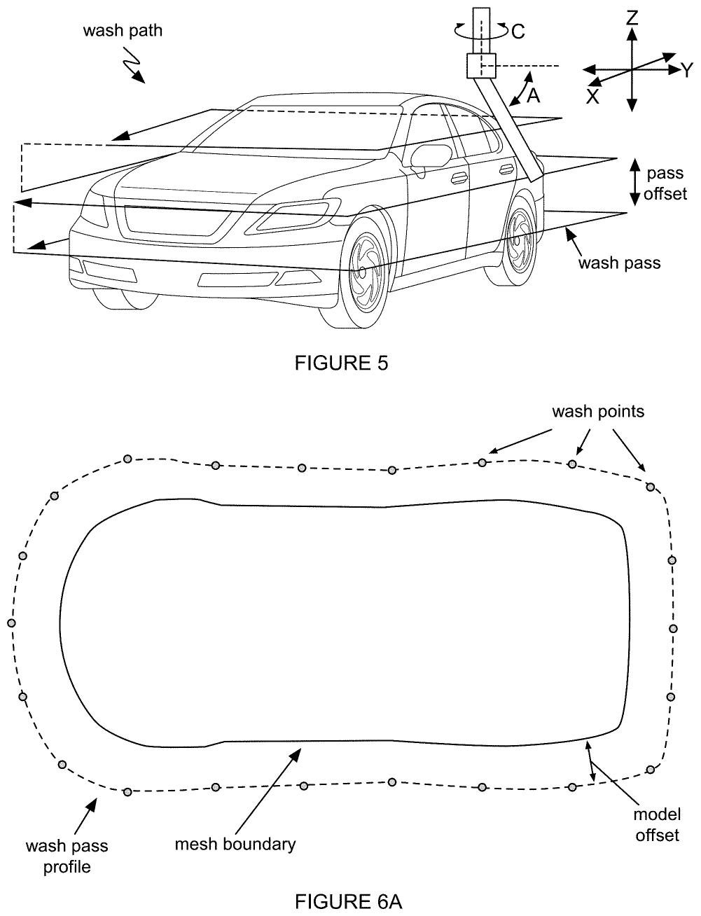

Actuation mechanisms can individually and/or collectively define any suitable range(s) of motion. Preferably, the collective ranges of motion along each axis allows the tool head and all components of the system to be simultaneously located outside of the working volume while performing cleaning/wash operation, but the system can be otherwise suitably configured. In a specific example, the (lateral) travel along the Y-axis is at least 80 inches. In a second specific example, the (vertical) travel along the Z-axis is at least 9 feet. Rotational actuation mechanisms can include a range of motion bounded by mechanical limits (e.g., imposed by the type of actuator, physical end stops, etc.) and/or software limits (e.g., restricting motion to avoid straining wires/tubes with excess coiling, sensing contact with a sensor such as a limit switch, limiting the force/torque exerted by actuators, etc.). In variants, cable (and/or tubing) management can provide the primary restriction for a rotational range of motion. Alternatively, one or more of the rotational actuation mechanisms can be unbounded/unrestricted about one or more axis—such as about an axis employing a slip ring connector and/or rotary union. In a specific example, a C-axis can include rotational bounds of +/−270 degrees about an origin (for a total rotational range of 540 degrees). In such cases, it can be beneficial to circumscribe the vehicle in opposing directions during adjacent vertical passes of a wash path, so as to avoid exceeding the rotational bounds of the C-axis (an example is shown in FIG. 5). In a second specific example, the actuation mechanism associated with the C-axis can include a range of motion of at least 3 full rotations (e.g., such that the system can continuously rotate in the same direction about a vehicle in the side wash configuration). In a third specific example, the actuation mechanism associated with the A-axis can include a range of motion of −10 to +190 degrees (for a total rotational range of 200 degrees). However, the various actuation mechanisms can include any suitable ranges of motion.

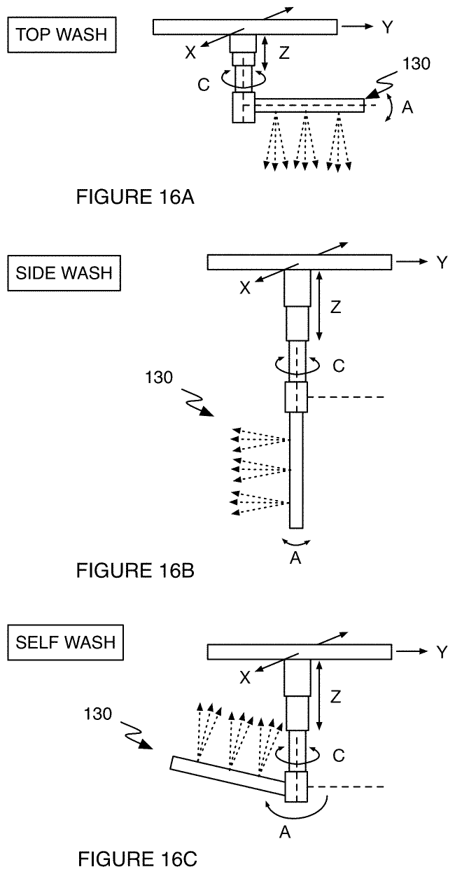

In variants, articulation of the A-axis can enable the tool head to be transformed between a plurality of wash configurations and/or wash modes. In a first specific example, the tool head can be configured in a ‘top wash’ mode with the nozzles directed substantially downwards (an example is shown in FIG. 16A; example wash paths in the top wash mode are shown in FIGURES 3A-B). In a second specific example, the tool head can be configured in a ‘side wash’ mode with the nozzles directed substantially laterally (an example is shown in FIG. 16B). In a third specific example, the tool head can be configured in a ‘self-wash’ mode (an example is shown in FIG. 16C) with the nozzles directed substantially upwards and/or towards the plurality of actuation mechanisms (e.g., A-angle of greater than or equal to 180 degrees)—which can be beneficial for periodic self-cleaning cycles. In some cases, cleaning vehicles with substantial mud or exterior debris build-up can result in such particulates ‘dirtying’ the vehicle washing system (e.g., the tool head), which can be mitigated by operating the vehicle washing system in a self-wash mode. However, the system can be otherwise suitably configured to provide self-washing and/or self-cleaning operation, or can be cleaned by secondary systems.

The actuation mechanisms can include any suitable types of actuators, such as: rotary actuators, linear actuators, electromechanical actuators (e.g., motors, servos, etc.), and/or any other suitable type of actuators. The actuation mechanisms can include any suitable drive mechanisms, such as: gear boxes, pulleys, harmonic drive mechanisms, turntables, ball screws, lead screws, rack-and-pinion systems, backdrivable mechanisms, non-backdrivable mechanisms, and/or any other suitable drive components.

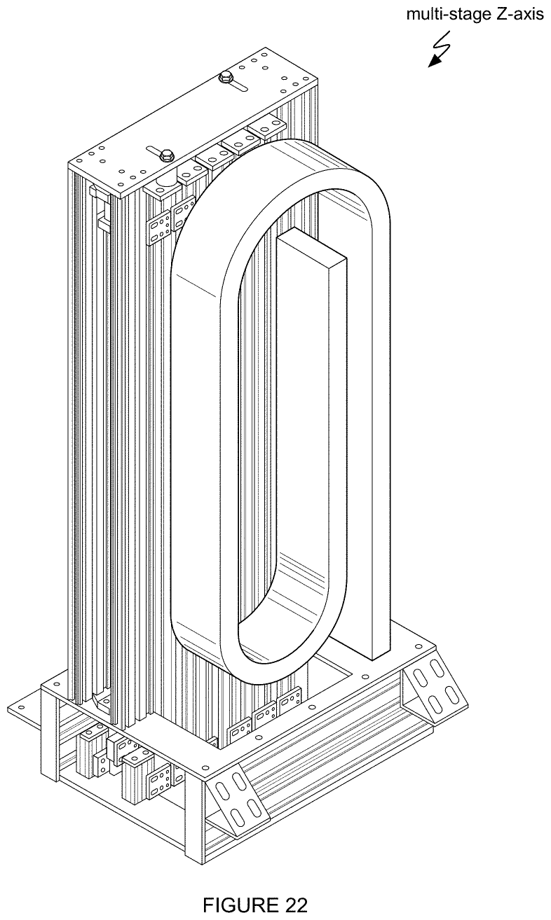

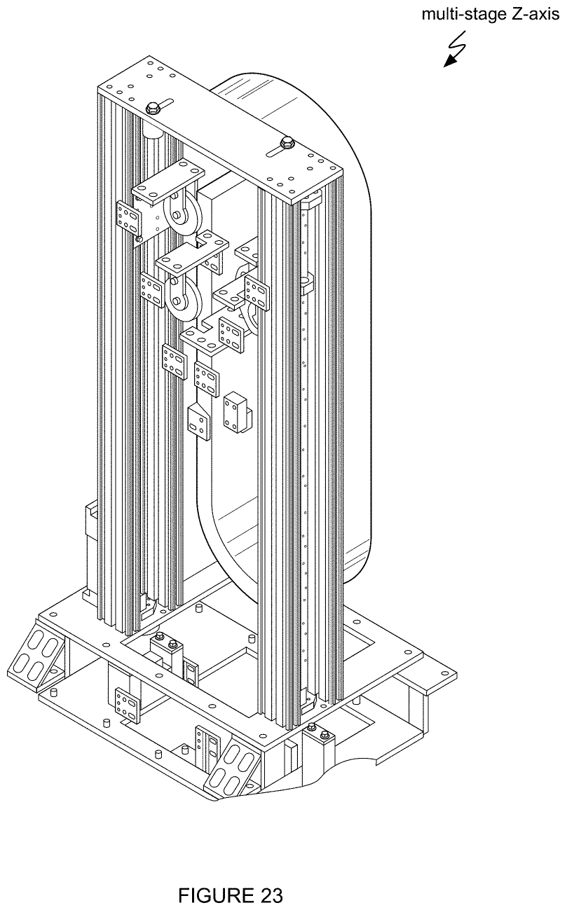

Linear actuation mechanisms can be single stage or multi-stage (e.g., include 2, 3, 4, more than 4 stages). In variants, the actuation mechanisms can include a multi-stage vertical axis. In a specific example, the vertical axis can include a 3-stage actuation mechanism. Multi-stage and/or telescoping actuation mechanisms can be driven by any suitable mechanisms. In a first specific example, multi-stage linear actuation mechanisms axes can be belt driven. In a second specific example, multi-stage actuation mechanisms can include redundant pulley systems connecting each stage, thereby ensuring that the failure of a single pulley/cable does not drop the tool head (e.g., when employed with non-backdrivable drive mechanisms such as a lead screws or ball screw). An example of a multi-stage Z axis is shown in FIGS. 22 and 23.

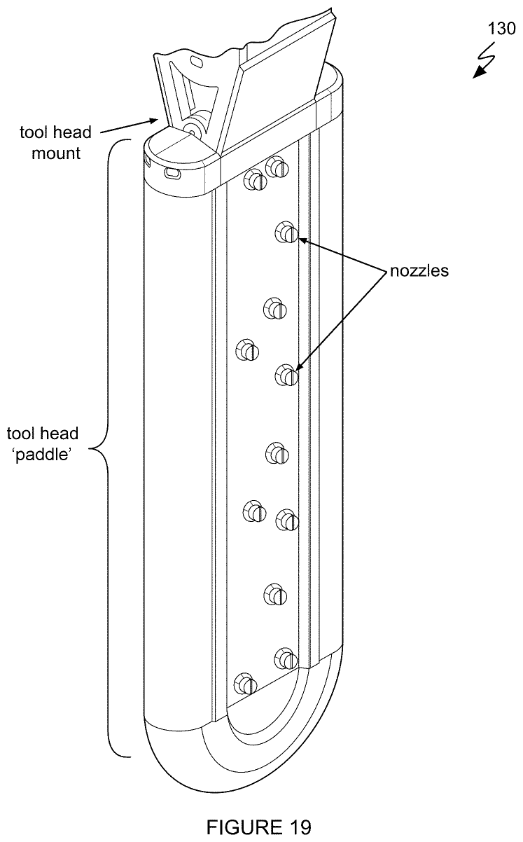

The tool head can be coupled to the various actuation mechanisms in any suitable manner, and the actuation mechanisms can be connected in any suitable order. Preferably, a base of the tool head (an example is shown in FIG. 19) can be mounted to a rotational actuation mechanism. More preferably, the base of the tool head is mounted to actuation mechanism associated with the A-axis, but can be otherwise suitably mounted. The rotational actuation mechanisms (e.g., the A and C axis actuation mechanisms) can be directly coupled to one another, but can be otherwise suitably configured. The rotational actuation mechanisms can be coupled or decoupled from the plurality of translational mechanisms. Preferably, all the rotational actuation mechanisms mount to and/or are coupled to the vertical translation actuation mechanism (e.g., the last stage of a multi-stage Z-axis actuation mechanism), but can be otherwise suitably configured. Preferably, the vertical translation mechanism can couple to the remaining translation actuation mechanisms (e.g., actuation mechanisms associated with the X/Y axes) in any suitable manner. In a specific example, the A-axis actuation mechanism is mounted to and configured to rotate based on a rotation of the C-axis actuation mechanism. In a second specific example, the C-axis actuation mechanism is mounted to and configured to translate based on an actuation of the Z-axis actuation mechanism. In a third specific example, the Z axis is connected to and configured to translate based on an actuation of the X and Y axes. The fluid manifold can be coupled to and/or configured to shift (e.g., translate and/or rotate) based on the actuation of each of the plurality of actuation mechanisms. However, the actuation mechanisms can be otherwise suitably coupled in any order or arrangement.

In variants, a portion of the fluid manifold extends about an axis each rotational actuation mechanism. Additionally, portions of wires/cables connected to the A-axis actuation mechanism can be configured to rotate about the C-axis based on an actuation of the C-axis, and similarly translate based on the actuation of each of the translational actuation mechanisms (e.g., X/Y/Z axes). Accordingly, the actuation mechanisms can include any suitable cable management components which function to regulate the motion of electrical harnessing and tubing (or other portions of the fluid manifold) extending therethrough. Wire/cable management can include: a rotary union and/or slip ring connectors arranged about one or more rotational axes, e-chain, excess wiring/tubing length (e.g., configured to wrap around a rotational axis), strain relief mechanisms, and/or any other suitable cable management components. In variants including a multi-stage and/or telescoping vertical actuation mechanism, cable/hose management can include an e-chain with multiple bend radii associated with distinct portions of the chain, which can prevent the e-chain from snagging or binding with other portions of the chain as is transitions between an extended and retracted configuration. In a specific example, an upper portion of the chain includes a first bend radius and a lower portion of the chain includes a second radius. A second example is shown in FIGS. 18A and 18B. However, the vehicle washing system can include any other suitable wire/cable management components, or can otherwise suitably regulate the motion of electrical harnessing and/or tubing.

The actuation mechanism can include any suitable component interfaces. In variants, the actuation mechanisms can include self-lubricating components at various movable interfaces. Self-lubricating components can include polymer bearings, Teflon-coated linear slides, and/or any other suitable components. Additionally or alternately, various component interfaces of the vehicle washing system can include un-lubricated components or otherwise operate without the use of oil, grease, graphite, or other lubricants at component interfaces. However, the actuation mechanism can include any other suitable interfaces.

However, the plurality of actuation mechanisms can include any other suitable set of features and/or components, and can otherwise manipulate the tool head in any suitable manner.

The fluid manifold functions to fluidly couple the tool head to a fluid source during cleaning operation. The fluid manifold can include tubing, piping, tanks, valves, regulators, and/or any other suitable fluid handling components. Various portions of the fluid manifold can be rigid, flexible, and/or rotatable (e.g., about an axis, multiple times about an axis), and can be constructed of any suitable materials such as: metals, plastics, polymers, rigid materials, non-rigid materials, or any suitable combination thereof. The material can be selected to correspond to the properties/requirements of the fluid (e.g., to avoid corrosion or other deleterious interactions, avoid degradation in high and/or low temperature conditions, meet pressure requirements, minimize head loss in circulation subsystem, etc.), but can additionally or alternatively be selected with any suitable basis. In a specific example, the fluid manifold can include a tool head insert forming a connection(s) between the inlet(s) at a base of the tool head and terminating at the set of nozzles.

However, the fluid manifold can include any other suitable set of features and/or components, and can otherwise fluidly connect the tool head to a fluid source.

The vehicle washing system 100 can optionally include one or more pumps, which function to move fluid through the fluid manifold. The pump(s) can additionally or alternatively function to increase the pressure of fluid within the fluid manifold (and/or provide pressurized fluid flow to the nozzles). The pumps can include any suitable type of pump action (e.g., centrifugal). The pumps can have any suitable size (e.g., 3o horsepower) and define any suitable flow rate (e.g., 2 GPM, 16 GPM), pump head, and/or any other suitable characteristics. In variants, the system can include a high-pressure pump (e.g., configured to deliver fluid to high pressure nozzles on the tool head) and a low-pressure pump (e.g., configured to deliver a cleaning agent to the tool head). Alternately, a single pump can transport both high pressure fluid and cleaning agents to the tool head. In variants, cleaning agents can include: low pH (acidic) cleaning agents, high pH (basic) cleaning agents, shine coating cleaning agents, and/or any other suitable cleaning agents. Cleaning agents can be dispersed simultaneously and/or asynchronously with water and/or other cleaning agents. Cleaning agents can be dispersed via the same set of nozzles of the tool head (and/or corresponding fluid lines of the fluid manifold) as pressurized water (e.g., high-pressure nozzles) and/or different sets (e.g., low pressure nozzles and low-pressure lines). Cleaning agents can be dispersed during any suitable wash passes/sequences, such as: top wash, side wash, and/or any other suitable tool head trajectories/wash sequences. However, the vehicle washing system can include any other suitable pumps, exclude a pump (e.g., and rely on external fluid pressure—such as supplied by a water main or gravity), and/or otherwise transport fluid through the fluid manifold.

The vehicle washing system 100 can optionally include a fluid reservoir which functions to store a fluid and/or can function as a fluid source for the fluid manifold. The fluid reservoir can store any suitable working fluid(s), such as water, cleaning agents, air, fluid mixtures, and/or any other suitable set of fluids. The fluid reservoir can include any suitable set of environmental protections (e.g., corrosion resistance), and can be airtight (or otherwise suitably protected from water/particulate ingresses) or fluidly coupled to the ambient environment. The fluid reservoir can define any suitable interior volume and/or storage capacity, but preferably includes sufficient capacity to enable cleaning operation across an entirety of a service interval (e.g., respecting average daily cleaning agent consumption). Alternatively, the fluid reservoir can be repeatedly, periodically, and/or continuously replenished within a service interval. However, the vehicle washing system can otherwise exclude the reservoir and/or provide fluid to the fluid manifold from any suitable set of fluid sources.

The vehicle washing system 100 can optionally include a heater which functions to provide thermal energy to fluid flowing through one or more portions of the fluid manifold—thereby increasing the fluid temperature. The heater can be any suitable type of heater (e.g., gas, electric, resistive, inductive, etc.). The heater can provide thermal energy at any suitable portion/endpoint of the fluid manifold. In a first variant, a heater can be arranged proximal to the fluid reservoir (>20 feet away from the nozzles along the fluid flow path) along a flow path of the fluid manifold. In the first variant, it can be advantageous to utilize separate nozzles and/or parallel flow paths for high pressure fluid, which does not include a temperature requirement, and high temperature fluid (e.g., including a cleaning agent which performs more effectively at high temperature) so that the system does not need to expend additional energy to heat the high pressure fluid. In a second variant, a heater can be provided proximal the nozzles along the fluid path, such as within an interior of the tool head, mounted to the tool head, mounted to one or more actuation mechanisms (e.g., actuated by one or more actuation mechanisms), and/or otherwise located proximal to the fluid. However, the vehicle washing system can include any other suitable heater, exclude a heater, and/or otherwise suitably heat the fluid.

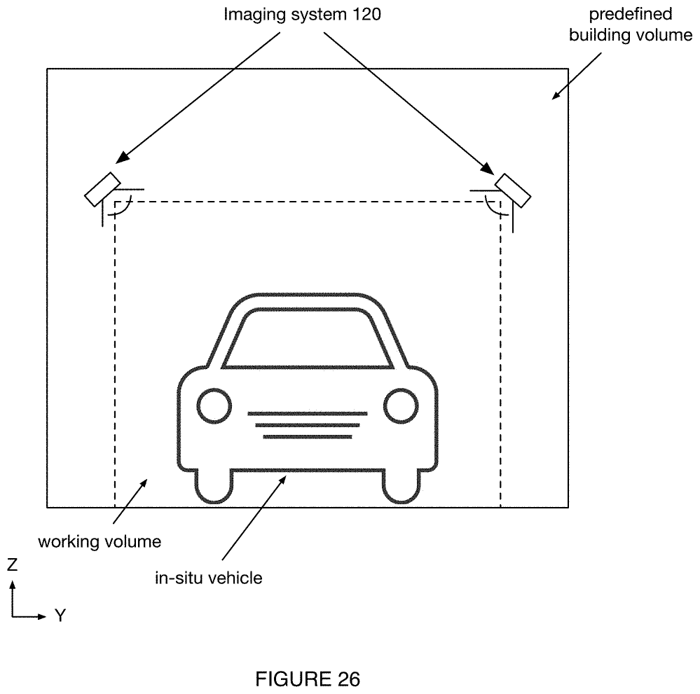

The vehicle washing system 100 can optionally include an imaging system which functions to scan the in-situ vehicle to determine a model for wash path planning. The imaging system preferably includes a time-of-flight sensor but can include any other suitable optical sensor(s) and/or other sensor. Preferably, the imaging system includes a Lidar system, but can include a camera system, radar system, electromagnetic scanning system, and/or any other suitable sensors. In a specific example, the imaging system (e.g., Lidar system) includes a 20 degree field of view in a downward facing direction (e.g., can have a 360 degree puck with a +/−10 degree width), but can include any other suitable sensing range. The imaging system can include a singular sensor and/or plurality of sensors arranged in any suitable manner. The imaging sensor(s) can be mounted to a portion of the actuation mechanism and/or configured to be actuated by one or more of the plurality of actuators, or can be otherwise mounted (e.g., statically mounted above a gantry system, multiple statically mounted sensors, etc.). In a specific example, the imaging system (e.g., Lidar system) is coupled to at least the X and Y actuation axes and is configured to be controlled along a peripheral path (e.g., at fixed/maximum height) to scan an in-situ vehicle. In a second specific example, the imaging system can include a pair of imaging sensors (e.g., Lidar sensors) coupled to the longitudinal (X) actuation stage above a working volume of the vehicle washing system. The imaging sensors of the pair can be arranged on opposing ends of the lateral actuation stage (e.g., spanning a full width of the working volume at the ends of the lateral actuation stage; an example is shown in FIG. 26). In a third specific example, the imaging system can include a plurality of sensors (e.g., four) which are fixedly coupled to a superstructure of a gantry system and/or which remain static while collecting measurements of the vehicle (e.g., without translating). However, the system can include any other suitable imaging system or exclude an imaging system.

The vehicle washing system can include a computing system which can function to perform one or more steps of the method, but can additionally or alternatively provide any other suitable functionality. The computing system can be local to the actuation system, remote, and/or otherwise located. The computing system can be centralized or distributed. The computing system can include one or more modules (e.g., controller).

The computing system can include a controller which can function to control the actuation mechanisms, the imaging system, and/or any other system components (e.g., pumps, fluid valves, etc.). The controller can be wirelessly connected, electrically connected, and/or otherwise connected to one or more components of the system. The control module can include a motion planner, which functions to determine control instructions for the actuation mechanisms to wash the vehicle according to the wash path (or trajectory). The motion planner can employ any suitable control scheme (e.g., feedforward control, feedback control, etc.). The control instructions can include a trajectory for the actuation mechanism(s) (e.g., and/or each axis thereof) in any suitable coordinate space (e.g., cartesian), and/or can include any other suitable control instructions (e.g., CNC waypoints, etc.). However, the vehicle washing system can include any other suitable controller, and/or can otherwise suitably affect motion/articulation of the actuation mechanism(s).

However, the vehicle washing system can include any other suitable set of components.

### 5. Method.

The method, as shown in FIG. 1, can include: sampling measurements of a vehicle in-situ S100, generating a model based on the measurements S200, and determining a wash path based on the model S300. The method can optionally include washing the vehicle according to the wash path S400. However, the method can additionally or alternatively include any other suitable elements. The method functions to determine control for a wash tool head to wash an in-situ vehicle. The method can additionally function to improve wash efficiency of automated vehicle washing systems by automatically determining a wash path that traces the peripheral shape of the vehicle, which can reduce wash time and fluid waste.

Sampling measurements of a vehicle in-situ S100 functions to determine the extent of a vehicle disposed within a working volume of the wash system. S100 preferably generates a point cloud in the machine reference frame (e.g., X/Y/Z coordinate position, with points posed relative to the working volume/machine translational axes, etc.), but can alternately generate any suitable data in any suitable format.

In a first variation, S100 includes moving the imaging system and sampling measurements along a scan path, and stitching the measurements together based on the imaging system location at each sampled measurement. The scan path can encompass: the entirety of the vehicle exterior, a portion of the vehicle exterior (e.g., surfaces over a minimum height, etc.), and/or other portion of the vehicle. In a specific example, S100 includes moving an imaging sensor(s) along the periphery of the working volume, sampling measurements of the in-situ vehicle, and generating a point cloud based on the measurements. In a second specific example, an imaging sensor which is arranged on the gantry system (e.g., coupled to the X and Y stages) is controlled about a predetermined peripheral scan path while collecting image data (e.g., Lidar data). In a third specific example, a pair of imaging sensors can be disposed on opposition across a midsagittal plane of the working volume (e.g., at either end of the lateral actuation/Y stage; an example is shown in FIG. 26) and translated linearly along the length of the vehicle (e.g., along parallel scan paths). Image data can then be transformed into the machine coordinate frame, yielding a point cloud of registered image data (e.g., posed Lidar data) which corresponds to detections of the in-situ vehicle. It is understood that transformations of imaging data between various coordinate frames is known and established in the art, and thus coordinate frames may be referenced interchangeably herein for convenience.

S100 can include actuating the imaging system about a scan path, which functions to shift the field of view of one or more components of the imaging system and/or provide full coverage of the vehicle exterior (e.g., excluding a vehicle underside, full coverage of the vehicle body exterior, etc.). The scan path is preferably a predetermined path, but can be otherwise suitably determined. The scan path preferably defines a travel of the sensor(s) at a maximum height (e.g., entirely at max height, at max height over a portion of the scan path, etc.), but can alternately define a fixed height of the imaging component(s), and/or any other suitable height of travel. The scan path preferably defines a travel of the sensors along a periphery of the working volume (e.g., in the X-Y plane), but can define any other suitable travel of the sensor(s), such as along a boustrophedonic path, circular path, a linear path (e.g., such as for a pair of parallel linear can paths opposing across the width of the workspace) and/or any other suitable path. Alternately, imaging system components can remain static during a portion or entirety of S100. Preferably, the imaging components can be controlled along the scan path concurrently with collecting imaging data, such imaging data is stored and/or indexed in association with sensor position. Accordingly, the sensor data can be transformed in the machine coordinate frame (e.g., by a coordinate transform) using the sensor position at the time of data collection.

S100 can optionally include filtering the measurements, which functions to reduce and/or eliminate the influence of noise, extraneous detections, and/or reflections. Data can be filtered by any suitable processing techniques. The measurements (or post-processed data) can be filtered: in the machine coordinate frame (e.g., posed scan data, after transformation, etc.); before coordinate transformation (e.g., neglecting Lidar data above the gantry system), and/or at any other suitable point/time in the process. In a specific example, data can be filtered by eliminating points which have fewer than a threshold number of neighbors within a predetermined distance. In a second specific example, data can be filtered by segmenting a foreground from a background, and removing the background. However, posed scan data can be otherwise suitably filtered.

The tool head can be active or passive while sampling measurements according to S100. Preferably, S100 occurs prior to spraying fluid on the vehicle and/or prior to controlling the tool head within the workspace of the system, however S100 can occur with any other suitable timing and/or order relative to other method steps. In a first variant, the tool head can be operated during S100, such as to spray water and/or cleaning agents concurrently with S100 (e.g., where the tool head is disposed rearward of the imaging sensors along the scan path). In a second variant, the toolhead can remain outside of an imaging FOV of the imaging system during S100. In a third variant, the tool head can enter a FOV of the imaging system or workspace during S100.

However, S100 can otherwise suitably determine the extent of a vehicle disposed within a working volume of the wash system.

Generating a model based on the measurements S200 functions to construct a geometric basis for wash path generation. S200 can also impose safety restrictions on the wash path and/or provide simplifications of the vehicle exterior to improve wash efficiency (or reduce wash path length). The model is preferably a mesh (e.g., convex hull), but can be provided in any suitable data format (e.g., such as a 3D volume, point cloud, height map, contour map, etc.). The scan data and/or point cloud (e.g., posed in the machine reference frame) can be converted into a mesh (or any other data format) in any suitable manner.

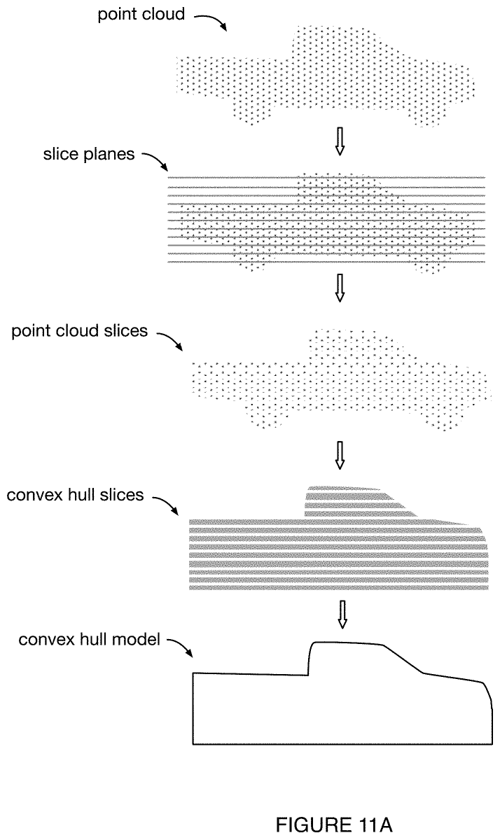

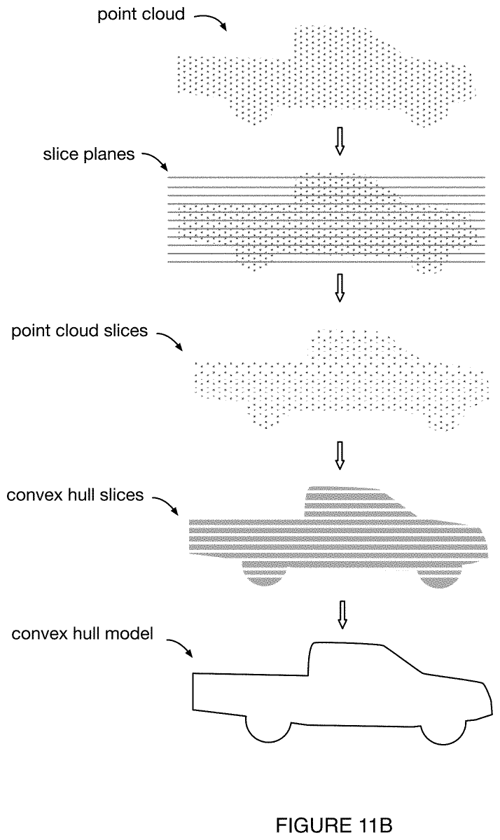

In one variant, S200 can include: slicing the measurements; generating a mesh for each slice; and generating a vehicle mesh from the slice meshes (an example shown in FIG. 11A; an example is shown in FIG. 11B). S200 can optionally include: removing peripheral vehicle features; generating a mesh for each peripheral feature; merging the peripheral feature meshes with the vehicle mesh; thickening the model; and removing overhangs. However, S200 can be otherwise performed.

Slicing the measurements (e.g., point cloud), functions to segment clusters of detections, such that a higher-resolution vehicle mesh can be generated (example shown in 10B, as compared to mesh generation without slicing shown in 10A). The measurements are preferably sliced into a vertical stack of lateral segments, but can alternatively be sliced into a lateral stack of vertical segments, sliced diagonally, or otherwise sliced or segmented. The measurements can be sliced into any suitable number of slices of any suitable height/thickness. The slice parameters (e.g., thickness, numerosity, distribution, etc.) can be predetermined (e.g., fixed thickness, etc.), dynamically determined (e.g., based on a maximum vertical extent of the vehicle, vehicle contour complexity, etc.), and/or otherwise determined. Slices can have uniform height/thickness and/or variable thickness. In a specific example, the slice height is less than the span (or characteristic length) of the wash tool head. However, the data can be otherwise suitably sliced.

Generating a mesh for each slice functions to generate a mesh for a segment of the vehicle, which realizes the vehicle contours. Generating the mesh can additionally function to fill in transparent exterior features (e.g., windows, headlamps, etc.) which may not be detectable/observable by the imaging system (e.g., the lidar might not detect windows). In a specific example, the frame surrounding is detected and the window is not detected, and a convex hull spanning ‘gaps’ in the scan data naturally completes the window geometry. The mesh is preferably a convex hull, but can alternatively be an affine hull, linear hull, conical hull, visual hull, and/or other mesh.

Generating a vehicle mesh from the slice meshes functions to join the various slices into a singular geometric model. The geometric model is preferably a mesh (e.g., with uniform or variable polygons), but can alternatively be a 3D volume or be otherwise represented. In a first variation, this includes: merging the slice meshes together, according to their respective positions in the slice stack. In a second variation, this includes: converting each slice mesh into a 3D volume, merging the 3D slice volumes (e.g., summing or joining the volumes), and converting the merged volume into a mesh (e.g., determining a convex hull for the merged volume). However, the slices can be otherwise merged.

In alternative variants, S200 can include fitting a 3D surface(s) over any suitable subsets of point cloud data, such as fitting 3D surface (e.g., polynomial fitting, least squares fitting, etc.) and/or generating a wireframe mesh from the filtered point cloud. In alternative variants, S200 can include generating a flat-sided model by defining a projected area, setting a plurality of grid regions within the projected area of the point cloud, and determining a height (e.g., max height or median/mean height of points falling within the grid region, etc.) and/or surface normal for each of the grid regions (e.g., plane fitting, etc.). In an alternative variant, a vehicle model can generated and/or parameterized by determining a 2D projection (top view; X/Y boundary; maximal X/Y convex hull) of the point cloud and a 2D height profile (X/Z) of the vehicle, where the 2D height profile takes the max height of the point cloud at each X value (e.g., assuming flat sides and low sensitivity to changes in height across the width). In an alternative variant, the model can be generated by determining a reference position (e.g., center point, characteristic length along a central axis, etc.) for a previously generated and/or stored vehicle model (e.g., for a subscribed carwash user with a vehicle ID/tag), such as by retrieving the vehicle model from a reference database. In such instances, the previously generated vehicle model can be validated and/or updated based on the point cloud, such as by determining each point of the point cloud is within a threshold deviation of the stored vehicle model associated with the vehicle ID/tag. However, the vehicle model can be otherwise suitably determined.

S200 can optionally include removing peripheral vehicle features which extend from the vehicle body (e.g., beyond a predetermined distance). Peripheral vehicle features can include: side mirrors, antennas, spoilers, wings, fins, flanges, and/or any other peripheral vehicle features. In a first variant, peripheral vehicle features can be removed prior to measurement slicing (e.g., removed from the point cloud prior to model/mesh generation). In a second variant, peripheral vehicle features can be removed from the measurement slices, before they are converted into a convex hull. Peripheral vehicle features can be identified based on a profile curvature, relative position/height in the measurements, predetermined position in the measurements (e.g., determined based on the feature's position in a reference vehicle model for the vehicle's make and model), size (e.g., determined based on the point cloud cluster's size), according to set of identification heuristics and/or otherwise determined. In a first variant, removed peripheral vehicle features can be neglected for a remainder of the method (unused). In a second variant, removed peripheral vehicle features can be separately modeled (e.g., converted into convex hulls independently of the vehicle body; etc.) and subsequently rejoined with the model (e.g., such as during thickening, in volume space, mesh union with convex hull of vehicle, etc.). In an example, generating the model of the vehicle further include: subdividing the imaging dataset into the vehicle body dataset and a side-mirror dataset; wherein generating the model using the convex hull of each slice includes: generating a vehicle body model based on the vehicle body dataset; generating a side-mirror model based on the side-mirror dataset; and combining the vehicle body model and the side-mirror model into the model.

However, peripheral vehicle features (e.g., side mirrors) can be otherwise removed and/or managed.

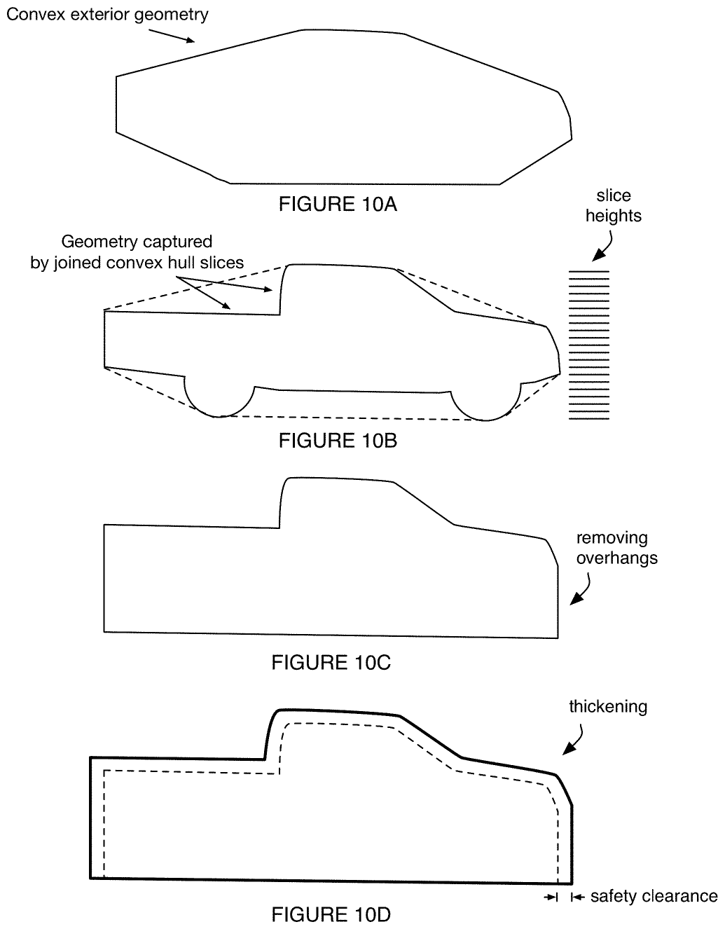

S200 can optionally include thickening the model, which functions to provide a safety clearance from the vehicle (e.g., to avoid collision of the tool head with the vehicle). The safety clearance can be predetermined, dynamically determined, determined based on a deflection and/or tolerance of the gantry system, and/or otherwise suitably determined. The model can be thickened by any suitable processing sequence. In a first variant, the convex mesh is thickened in the direction of the surface normal by the clearance distance. In a second variant, the mesh is converted into a 3D volume (e.g., volume space) where the model is extruded outwards by the clearance distance. In a specific example of the second variant, the thickened 3D volume is subsequently converted back into a mesh. In a third variant, the slice meshes are thickened (e.g., orthogonal to the slice stack axis, in all dimensions, etc.) before rejoining. However, the model thickening can be performed at any other suitable step. In a second specific example of the second variant, the removed peripheral vehicle features can be rejoined with the vehicle in the 3D volume space during thickening (e.g., as a multi-body volume). An example of thickening the model is shown in FIG. 10D. However, the model can be otherwise suitably adjusted.

S200 can optionally include removing overhangs, which functions to ensure that overhanging features are not impacted by the tool head while washing the surface below. Additionally, removing overhangs can function to simplify the model by eliminating complex and/or un-utilized geometry (e.g., the underside of the vehicle which can be un-washed). In a first variant, overhangs can be removed during slicing, by projecting each detection or the slice boundary into the planar slice(s) below it (e.g., along the Z direction) and ensuring that the lower slice's boundary encompasses the projection. In a second variant, overhangs can be eliminated by projecting the profile of each convex hull into the slice(s) below—restricting the lower convex hulls to not encroach/intrude upon an outer X/Y boundary the above profile(s). In a third variant, overhangs can be eliminated in the volume space (e.g., by projecting the model down to a base-plane of the vehicle (e.g., predetermined, determined by a background of the scan data, etc.). A specific example of overhang removal is shown in FIG. 10C.

Overhangs are preferably removed after the peripheral vehicle features are eliminated from the model, but can occur with any other suitable timing/ordering within S200. In variants, slices can be processed from top to bottom (e.g., in the vertically downward direction), which can improve efficiency of removal of overhanging geometry. However, overhangs can be otherwise suitably removed.

In a first variant, generating the vehicle model can include: slicing an imaging dataset horizontally to generate a set of data slices, each data slice comprising a vehicle body dataset; for each vehicle body dataset, generating a convex hull (e.g., for the data slice); generating a model using the convex hulls of each slice, including: removing overhangs within the model.

In variants, S200 can optionally include determining a coarse vehicle model, which functions to determine a maximal bounding box which may enable execution of initial cleaning sequences (e.g., chemical passes; passes which may be effective even for large offsets from the vehicle) during generation of a second (granular) vehicle model (e.g., vehicle mesh, etc.). The determining coarse vehicle model can include: determining maximal longitudinal bounds, determining maximal lateral bounds, determining a central axis of the vehicle, determining an upper (vertical) bound, and/or determining any other suitable coarse model parameters. A coarse vehicle model can be used to validate a precomputed wash path (e.g., chemical wash path) and/or to set longitudinal, lateral, and/or vertical bounds for a coarse cleaning pass (e.g., chemical agent dispersal). The coarse vehicle model is preferably determined based on the maximal values of the imaging data (e.g., in one or more coordinate axes). As an example: the coarse vehicle model can be a bounding box, which can be determined based on the extrema coordinate values in X, Y, and Z (e.g., a minimum Z value can be set to a floor height of zero), where the bounding box can be defined by the maximal rectangular prism bounded by the respective ranges of coordinate values along each axis (e.g., the maximal bounding box; aligned with the orthogonal axes of the coordinate frame). In variants, the maximal bounding box can be thickened (or a large offset can be applied) for any control instructions and/or wash paths calculated/executed based on the coarse model, such as during generation of a second (granular) vehicle model. However, the coarse vehicle model can be otherwise generated, or else not generated or used (e.g., when a computation time for granular vehicle model generation is within a threshold duration; for computation of wash paths which rely on a granular vehicle model, etc.).

However, the model can be otherwise generated.

Determining a wash path for the model S300 functions to determine the trajectory of the wash tool head to wash the in-situ vehicle. S300 can determine a single wash path (e.g., with a merged subset of different trajectories), a set of wash paths, and/or any other suitable wash path/trajectory for the model. The wash path preferably includes a set of wash points directing the intended travel of the wash tool head during a portion of a wash cycle, but can be provided in any suitable data format. The wash path can additionally include an orientation/angle (e.g., A-angle, C-angle) of the wash tool head at each wash point (and/or between wash points). The wash path is preferably determined based on a granular vehicle model (e.g., for vehicle model determined based on more than six points of the point cloud, such as a mesh determined by combining convex hulls according to S200), but can additionally or alternatively be determined based on a coarse vehicle model (e.g., bounding box according to S200). A wash path can include one or more of: a set of chemical agent passes and a set of pressurized water passes. In a specific example, a wash path can include a sequence of: a low pH chemical dispersion, a high pH chemical agent dispersion, a set of pressurized water passes (e.g., a top wash sequence followed by a side wash sequence), and a shine chemical agent dispersion.

The wash path can be determined: for one or more wash cycles; for different segments of the vehicle model (e.g., ‘top’ and ‘side’ segments); for all points surrounding a portion of the vehicle model; and/or for other vehicle segments or combinations thereof. The segment-specific wash paths can be stitched together into a sequence, be treated as separate paths, be concurrently executed, or otherwise managed and executed.

For instance, the wash path can include a top wash path (‘top’ wash variant) and a side wash path (‘side’ wash variant).

The top wash path can be associated with washing the top of the vehicle, hood of the vehicle, vertical projection of the vehicle, windshield (front and rear), truck, truck bed, upper portion of the vehicle, portion of the vehicle above a threshold height, and/or any other suitable portion of the vehicle. The top wash path can include a plurality of lateral wash passes (e.g., horizontal wash passes), but can alternately include longitudinal passes (e.g., lengthwise wash passes), and/or any other suitable geometry (e.g., spiraling, adaptive, etc.). In a specific example, the lateral wash passes can be connected to form a boustrophedonic pattern, but can alternately be connected in any appropriate manner. However, wash passes within the wash path can include any suitable geometry and/or relative arrangement, and/or can be otherwise suitably determined. Specific examples of top wash paths are shown in FIGS. 3A and 3B.

The side wash paths can be associated with washing the sides of the vehicle, doors, windows, front, rear, undercarriage, remainder of unwashed surfaces (e.g., after a top wash, before a top wash, etc.), portion of the vehicle below a threshold height, and/or any other suitable surfaces of the vehicle. The side wash path can include a plurality of planar wash passes (e.g., contours), each encircling a profile of the vehicle at constant height (e.g., fixed Z position) or within a range of heights (e.g., perturbations from an initial Z position), but can alternately include a spiral pass (e.g., simultaneously varying X/Y/Z position), and/or any other suitable geometries.

Additionally, passes and/or various portions of the wash path (e.g., in the first ‘top’ wash variant, in the second ‘side’ wash variant, etc.) can be offset from one another by a predetermined distance relative to the wash tool head constraints. In a specific example, the wash passes are offset from one another (e.g., in Z-direction, in X/Y plane, vector distance, etc.) by at least a threshold percentage (e.g., 80%) of the span of the wash tool head (or conversely the projection of the wash tool head on adjacent wash passes overlaps by at least a predetermined amount—such as 20%). Additionally or alternately, passes can be equidistant and/or uniformly distributed based on a minimum number of passes (e.g., three, four, etc.) and/or a vehicle model dimension (e.g., height, length) divided by the span of the tool head. Additionally or alternately, one or more parameters of a wash pass can be predetermined. In a specific example, the X-position of lateral passes is predetermined in the ‘top’ wash variant. In a second specific example, the Z-position of one or more ‘side’ wash passes is predetermined in the ‘side’ wash variant.

Wash passes and/or wash points within the wash pass can be ordered (e.g., sequentially, etc.) according to any set of predetermined rules, such as: front to rear (or rear to front), top to bottom (or bottom to top), opposite direction from opposing pass (e.g., clockwise followed by counterclockwise; left to right followed by right to left), same direction as previous pass (e.g., all side passes clockwise, all top passes left to right, etc.). However, wash passes and/or wash points within a wash pass can be unordered and/or otherwise ordered (e.g., based on adaptive determination). Different wash passes (e.g., adjacent wash passes, every other wash pass, etc.) can be connected (e.g., in a boustrophedonic pattern, striped pattern, etc.) to form the wash path. Additional intermediate wash points can optionally be calculated based on the determined wash points.

The wash paths are preferably determined based on a series of wash points, but can alternatively be predefined wash paths, be determined based on precomputed wash pass segments, or otherwise determined. S300 can include determining wash points based on the model, which functions to determine the position and/or orientation of the tool head such that it is offset from the boundary profile of the vehicle model by at least a predetermined model offset (e.g., optimal nozzle spacing range, predetermined value, nozzle spacing range less the safety clearance, etc.).

The tool head pose components (e.g., position, orientation) associated with each wash point can be determined: separately; concurrently; using a combination thereof; or otherwise determined. In a first example, each wash point's position (coincident with tool head position and/or reference position used to determine tool head position) is determined separately from its orientation. In a second example, each wash point's pose is concurrently determined in a bundle adjustment or in an optimization. In a third example, the orientation can be first determined and used to constrain the position determination. However, the wash point pose can be otherwise determined.

In a first variation of S300 (e.g., the “top wash variant”), the wash points can be determined by: selecting the X/Y positions (e.g., lat/lon position), and subsequently determining an associated Z-position. In a specific example, this variant is used to determine the wash path for the upper vehicle surface (‘top’ wash variant).

Selecting the set of X/Y points includes determining a set of wash passes, each having a different X-position (or, conversely, Y-position). The wash pass location, geometry (e.g., linear, curved, etc.), and/or spacing can be predetermined (e.g., based on the wash head's span), determined based on the vehicle model, or otherwise determined. Each linear wash pass can have a set of wash points, each located at a Y-position (or conversely, X-position) along the respective wash pass. The wash point's position along the wash pass can be: predetermined (e.g., pre-selected), dynamically selected based on the vehicle model, determined based on an adjacent wash point (e.g., equally spaced), or otherwise determined. Alternatively, selecting the set of X/Y points includes retrieving a predetermined grid of X-Y positions (e.g., wherein the respective Z-positions are determined as the Z-position at which the grid intersects the vehicle model). However, the X/Y positions can be otherwise determined.

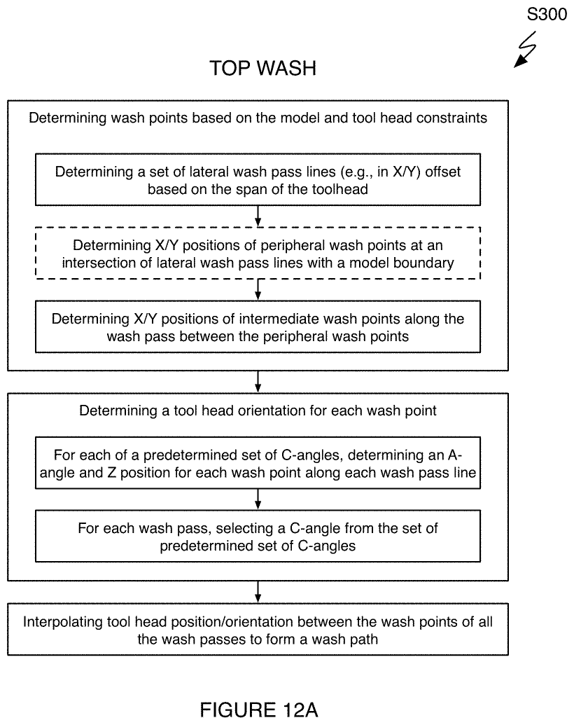

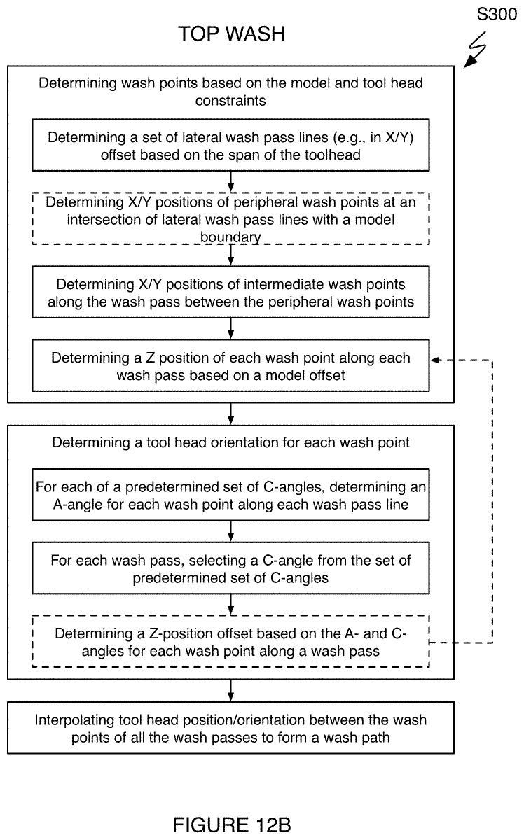

In a specific example of selecting the set of X/Y points, the wash points that are analyzed are limited to those within the vehicle model's boundary in the X-Y plane; alternatively, all wash points can be analyzed. In this specific example, the boundary can be the peripheral boundary of the top-view (vertical) projection of the model into the X-Y plane. In variants which eliminate overhangs, the profile can additionally or alternately be taken as the peripheral boundary of the model/mesh at ground level. The wash points can include peripheral wash points (e.g., X/Y corner points of the boustrophedonic pattern) which can be selected as the intersection of lines (in X/Y plane) extending in the direction of each wash pass (e.g., constant X lines for lateral wash passes, constant Y lines for longitudinal passes, etc.) with the peripheral boundary of the planar profile of the vehicle (e.g., as shown in FIGS. 12A-B). For each pass, intermediate wash points can be selected between the peripheral wash points in any suitable manner (e.g., uniformly, fixed number, fixed spacing, dynamically determined, etc.). Peripheral wash points on adjacent passes can be connected in any suitable manner, such as boustrophedonically with a direct vector to the adjacent peripheral wash point (an example is shown in FIG. 3A), boustrophedonically with asynchronous X/Y/(Z) travel (an example is shown in FIG. 3B), and/or in any other suitable manner. However, in the ‘top’ wash variant, the X/Y position of wash points can be otherwise suitably determined based on the planar profile of the vehicle (or not determined based on the planar profile of the vehicle) and/or the planar profile can be otherwise suitably determined.

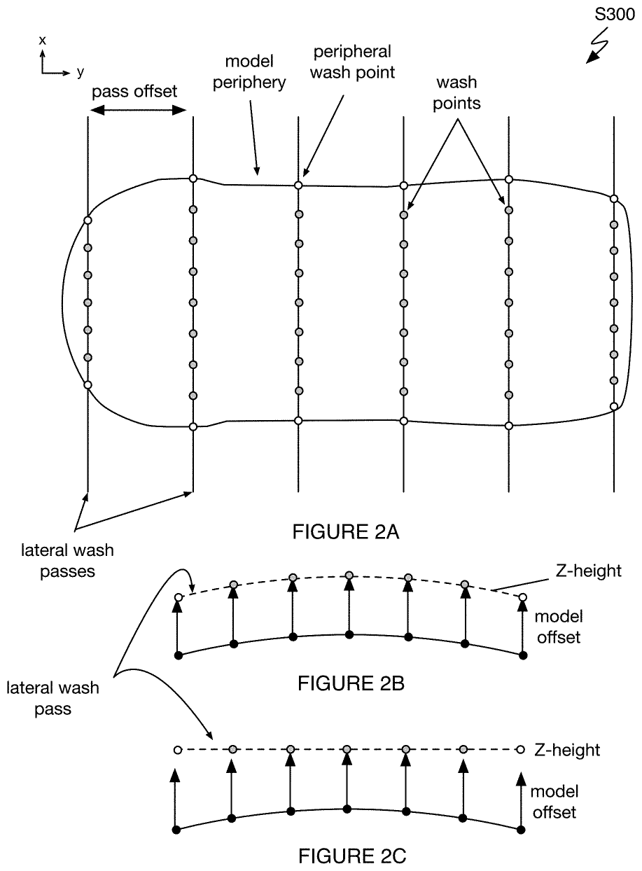

The Z-position for each wash point can then be determined based on the X/Y positions. In a first example, the Z-position for each wash point can be determined as the vehicle model's depth (e.g., from the top of the working volume) or height (e.g., from the bottom of the working volume), based on the vehicle model. This can be determined by: projecting each X/Y point downward or tracing a ray downward until the point or ray intersects the model, projecting an area of the wash tool head downward (located at the X/Y point in any suitable orientation) until it first intersects the model, or otherwise determined. A safety distance (e.g., away from the vehicle model; which can be predetermined and/or dynamically determined) can optionally be added to the Z-distance analysis. Z-positions that fall below a predetermined height (e.g., above a predetermined depth) can be ignored or removed. In a second example, the height of the model is determined for each X/Y wash point position within a wash pass (e.g., the points limited to the vehicle profile projection into the X/Y plane), and the maximum height of the model across all the wash points in the wash pass (periphery and intermediate wash points) is selected as the height of all wash points within the wash pass (an example is shown in FIG. 2C). In a third example, the height can be adjusted/modified based on a tool angle offset at the wash point (e.g., to avoid impacting the surface, as shown in FIG. 12). An example of a tool angle offset is shown in FIG. 4. However, the vertical position of wash points can be otherwise determined.

In a second variation of S300 (e.g., the “side wash variant”), the Z coordinate can be predetermined (or determined before the X/Y positions), and the X/Y positions (or lat/lon position) can be subsequently determined. In a specific example, this variant is used to determine the wash path for the vehicle sides (‘side’ wash variant).

In this variation, determining the wash points includes: selecting a set of Z points and determining the X/Y position of the vehicle's side surface for each Z point.

Selecting the set of Z points includes determining a set of lateral (side) wash passes, each having a different Z-position (e.g., height), where the Z-position can be determined in the same or different manner as that described above for the first variant's wash passes. Each lateral wash pass can extend: horizontally (e.g., flat; be a planar pass), at an angle (e.g., angled upward), or be otherwise oriented. Each lateral wash path can be predetermined, determined based on the vertical extent of the model, determined based on the measurement slices, selected to surround the vehicle model but not intersect the model, or otherwise determined. A set of wash points (e.g., Z-points) can be defined along each lateral wash path (e.g., equidistant, based on model curvature, etc.). However, the Z positions can be otherwise determined.

Determining the X/Y position functions to determine the remaining components of each wash point's position.

In a first example, the X/Y position of each Z-point is determined by intersecting the Z-point with the vehicle model (e.g., by tracing a ray from the Z-point along the X/Y plane into the model—such as towards a center-point/centerline; by determining one or more model points corresponding to the Z-point; etc.).

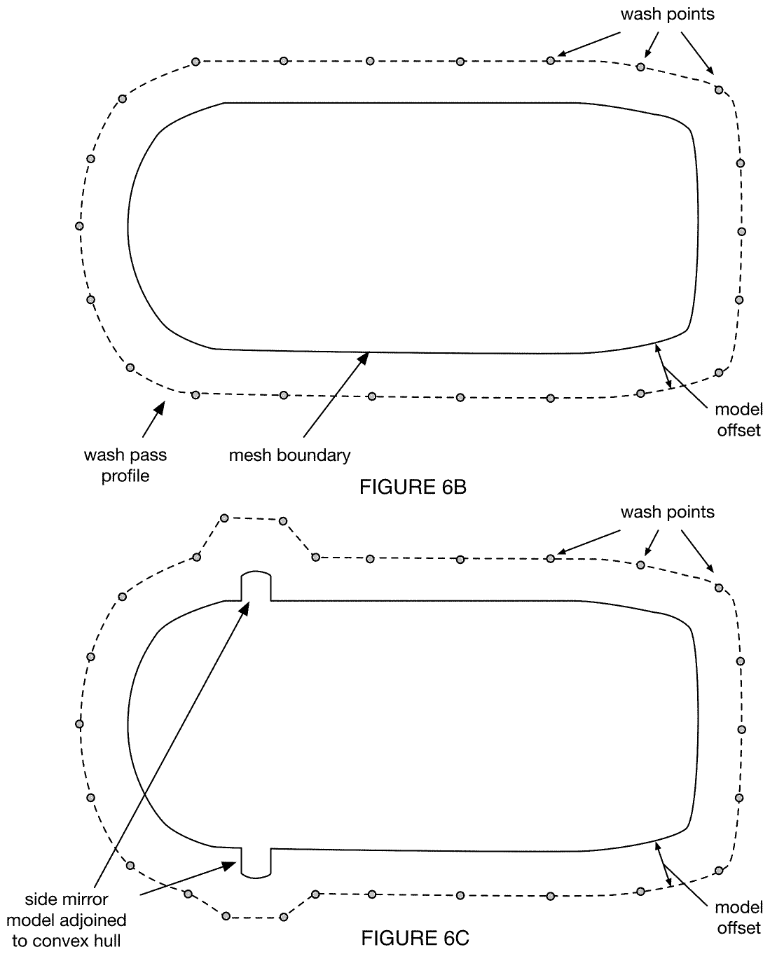

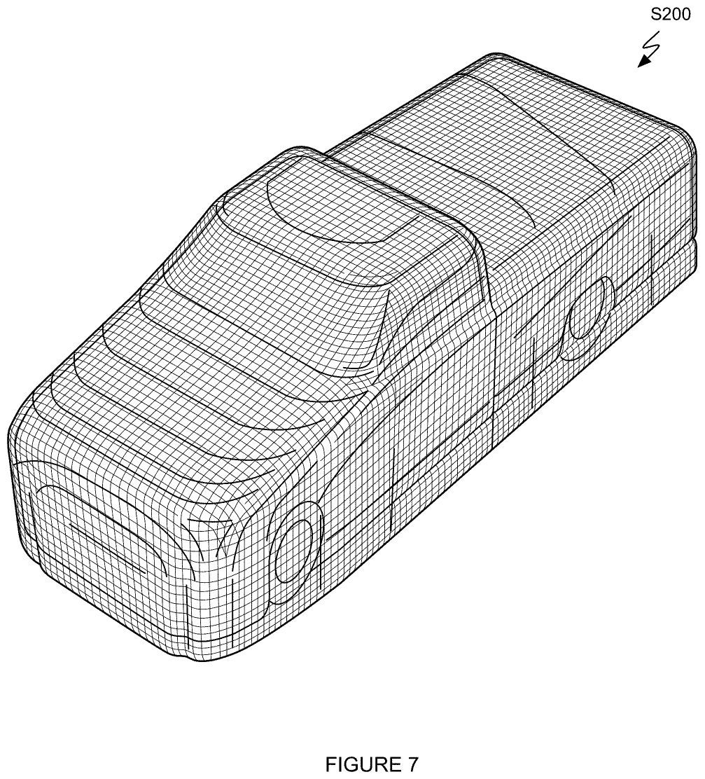

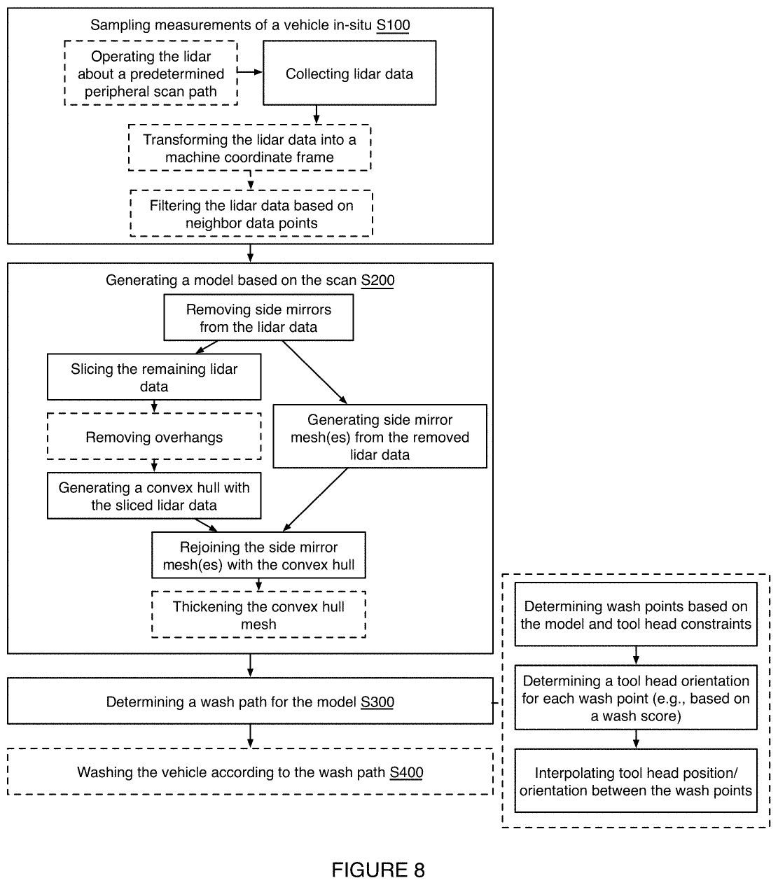

In a second example, the X/Y position of each Z-point (or Z-range) is determined based on the profile of the vehicle, which can be taken as the peripheral boundary of the model/mesh at the height of the planar pass, however the profile can be otherwise suitably determined. This can be particularly useful for the ‘side’ variant. For each lateral pass, the X/Y positions of wash points can be determined as over any suitable interval on the profile—which can be a uniform angular spacing about a vertical axis of the model (e.g., center), a predetermined/dynamically determined path length interval along the profile of the vehicle, and/or otherwise suitably determined. For the profile interval, the X/Y positions can be determined by offsetting the wash point from the profile by the model offset (e.g., along a surface normal, along a vector from the vertical axis to the profile position, orthogonal to a tangent of the profile in the X/Y plane, and/or otherwise suitably determined. An example of the wash pass profile is shown in FIG. 6.

In a third example, the X/Y position of each Z-point is determined as an angular region (e.g., or angular volume for a range centered about the Z-point) about a vertical axis of the model (e.g., center), such as a for a predetermined and/or dynamically determined angular step size. The X/Y(/Z) position of the wash point can be taken as any point within this angular region and/or subsequently optimized according to a wash score (e.g., by perturbations from a center of the angular region). However, the X/Y positions of the wash points can be otherwise suitably determined.

In a fourth example (e.g., such as in instances where overhangs have been removed from the model), each side wash pass encircles the model and is vertically offset from adjacent side wash passes of the plurality based on a span of the wash tool head, wherein each side wash pass inclusively bounds an interior region, the interior region spanning a vertical projection of each wash point of each side wash pass of the plurality lying above the interior region. In a specific example, the area bounded by lower wash passes are larger than the areas bounded by higher wash passes.

In a third variation of S300, the X, Y, and Z coordinates can be simultaneously selected according to a helical function about a vertical axis (or other center-point, line, etc.) of the vehicle.

In a fourth variation of S300, the wash path can be determined based on a coarse vehicle model. In a first example, a wash path can be precomputed and set based on a determination that the vehicle is bounded within the working volume of the vehicle washing system and/or determining that the height of the model is less than a first predetermined height (e.g., where the wash pass at a second predetermined height. In a second example, a wash path can be determined based on the length and/or central axis of a coarse vehicle model, such as by setting a height of a wash pass a predetermined distance above the bounding box and setting a length of the wash pass based on the length of the coarse vehicle model.

However, any suitable set of coordinates can be preselected and/or computed based on the vehicle model in any other suitable manner.

Determining a wash tool head orientation for each wash point functions to determine the direction the wash tool head should point during a wash cycle, ensuring water is directed toward the vehicle. Additionally or alternately, determining a wash tool head orientation can function to reduce unnecessary rotations of the tool head and/or ensure rotations satisfy the constraints of the gantry system. Preferably, the wash tool head orientation at the wash point is selected which maximizes a wash score at a particular point (or conversely minimizes a wash score—for a cost minimization function rather than an energy maximization function), but can be otherwise determined. The ‘wash score’ can be determined by any suitable function, which can include: a penalty associated with any portion of the head/gantry system contacting the vehicle model or exceeding system limitations (e.g., violating bounds of X/Y/Z/A/C), a score assigned based on an angle of incidence between a normal vector of the wash tool head and the model surface, a score assigned based on the distance (e.g., minimum, average, etc.; minimum tool angle offset; spray distance) of a normal vector of the wash tool head and the model surface. In variants, the wash score for a particular wash point and/or the total wash score for a wash pass can be calculated as the sum of the wash scores for all associated vertices (e.g., for uniform/evenly spaced vertices) on the model—such as all vertices within a particular height range on the vehicle.

In a first variation of orientation determination (e.g., used in the ‘top’ wash variant), determining a wash tool head orientation preferably includes, for each of a predetermined set of C-angles (e.g., 0 and +180 degrees; −90 and +90 deg, etc.), determining an A-angle for each of the wash points. In a first specific example, the A-angle that results in the lowest Z-position for each C-angle of the set is calculated. The A-angle can be calculated by dropping a virtual tool head until the tool head intersects a point on the model (e.g., thereby refining the Z-position), and rotating the tool head about the A-axis until the virtual tool head intersects another point on the model (e.g., separated from the first point by a predetermined distance). In a second specific example, an A-angle that maximizes (or minimizes) a wash score is calculated. The A-angle which maximizes the wash score is the A-angle which minimizes a tool angle offset at the wash point. An example is shown in FIG. 4. In a third specific example, A-angle can be bounded based on a range of motion of the A-axis (e.g., −10 to 100 degrees) for a particular wash point. In a fourth specific example, the A-angle can be determined by evaluating a set of ‘high points’ which lie under a vertical projection of the wash head (while at the predetermined C angle). For each of the set of high points, the minimum rotation of the head can be determined which intersects the high point and exactly one other point on the model which is separated from the high point by at least a minimum distance (e.g., 1 cm—to avoid errors in the case of sharp deviations near the high point). When multiple feasible A-angles are determined for a given C-angle, the A-angle can be selected from the resulting set of angles as the A-angle which results in the lowest tool height (e.g., evaluated from the center of the wash tool head; aka requiring the minimum tool angle offset).

In this variant (e.g., “top wash variant”), after the A angles are determined for each wash point for each of the set of C-angles, a C-angle can be selected for each pass. The C-angle can be held fixed for each pass, but can be otherwise suitably implemented (e.g., with minor C-angle variations per pass). The C-angle for a wash pass can be selected: based on a wash score, based on the number of feasible and infeasible A-angles for the given C-angle, based on a set of heuristics (e.g., use the prior pass's C-angle), or otherwise determined. For example, if multiple C-angles result in the same wash score, or a result in wash score within a predetermined threshold difference, the C-angle can be selected to correspond to the C-angle of an adjacent wash pass (e.g., to minimize the time associated with C-rotation)—such as the preceding (or subsequent) wash pass in a boustrophedonic wash pattern. In a specific example, for each wash pass, the C-angle can be selected between a forward and rearward azimuthal orientation of the tool head based on the tool elevation angles of the wash pass and an elevation range of motion of the tool head. Once the C-angle is selected for each of the wash points, the coinciding A-angle (previously determined for the same wash point and C-angle) can be selected, fully defining the wash point. In a specific example, the Z-position of a wash point can be adjusted by the tool angle offset after the selection of the A and C angles.

However, the orientation of the wash points can be otherwise suitably determined in the ‘top’ wash variant.

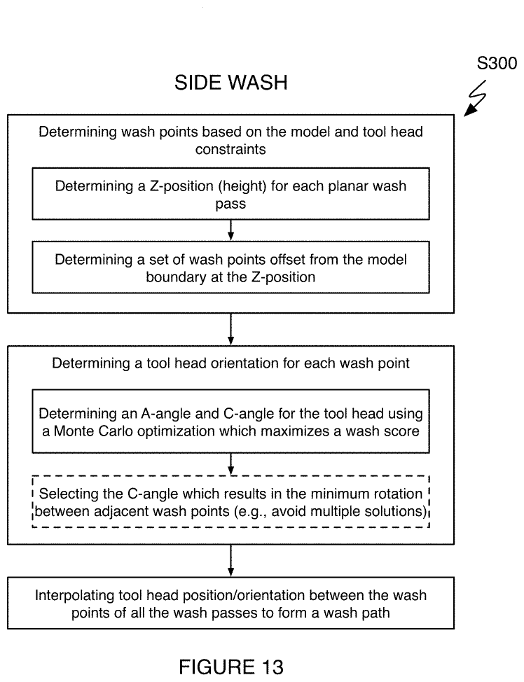

In a second variation of orientation determination (e.g., in the “side wash variant”), the A and C angles for each wash point can be determined based on optimizing a wash score. In a specific example, the A/C angles are selected for each wash point (e.g., randomly, using a Monte-Carlo optimization, etc.), and a score is determined for the selected X/ Y/ Z/ A/ C combination based on whether the wash tool head: contacts/intersects the model/mesh (e.g., lowest awarded score; highest awarded score, large penalty), is within the working limits of the gantry system (e.g., penalty for tool head outside of the gantry system), falls outside of the model, a wash efficacy metric (e.g., a measure of how well it washes the vehicle according to the model, such as based on historical wash outcomes and/or estimated/modelled efficacy; score assigned based on angle of incidence between a normal vector of the wash tool head and model, score assigned based on distance from the model/mesh; no penalty). The pose with the highest awarded score or lowest penalization score can be selected as the pose for the wash point. In cases where the wash score is identical by symmetry for multiple C positions (e.g., +180 & −180 degrees, which correspond to the same orientation but with different actuation), the C position can be selected which requires the least C-rotation from a neighboring/adjacent wash point within the wash pass (or along the wash path, with a specified direction of travel for ordered wash points—thereby breaking ties between wash scores corresponding to multiple valid head pose solutions (e.g., as shown in FIG. 13).

However, the A and C angles can be otherwise suitably determined.

In variants, the wash score optimization can additionally allow perturbations/deviations of tool head position from the wash point position (in X, Y, and/or Z), such as vertical deviations within a height range or angular region of a wash point, and can optionally assign a penalty to such deviations. Accordingly, such variants can enable the X/ Y/ Z/ A/ C angles to be concurrently/simultaneously optimized for each wash point (e.g., within an angular volume/range, about an initial position, etc.). In variants, the wash score optimization can additionally or alternatively include a penalty based on a required tool head acceleration and/or traversal time along a trajectory spanning the nearest adjacent wash points (e.g., preceding, trailing, etc.; 3 wash points, 5 wash points, etc.) of the sequence, where the magnitude of the penalty is weighted based on relative acceleration constraints among a plurality of actuation axes. As an example, longitudinal (X) accelerations and/or lateral (Y) accelerations can be more rate limiting on transformations along the trajectory than angular accelerations (e.g., in A or C), which can make angular adjustments faster and/or more efficient than translational adjustments in some cases. However, the pose can be otherwise suitably determined and/or optimized.

The wash path can be determined from the set of wash points, by interpolating angles and coordinate positions between the wash points in any suitable manner. Preferably, the wash path is determined by interpolating between wash points according to their order within the wash passes, and between wash passes according to their order. Alternately, each wash point can alternately be interpolated according to a global order. However, orientation and coordinate positions can be otherwise suitably determined between wash points.

However, the wash path can be otherwise suitably determined.

The method can optionally include washing the vehicle according to the wash path S400, which functions to clean the in-situ vehicle by controlling the wash tool head along the wash path. Washing the vehicle can include any suitable wash cycles, during which fluids such can be directed by and/or sprayed from the wash tool head. Fluids can include: air (e.g., hot air), steam, pressurized water, cleaning agents, and/or other suitable fluids. During a wash cycle, the wash tool head can follow the wash path and/or intersect the wash points once, but can alternately follow the wash path multiple times—such as for repeat passes (e.g., pressure spray pass, cleaning agent pass, rinse pass, drying pass, etc.). Preferably, the wash path. In variants, multiple tool types—such as pressure nozzles and cleaning agent nozzles—can follow the same wash path for independent passes within a wash cycle (e.g., with a tool change, where both tool types are arranged on the wash tool head, etc.) or can follow different wash path (or are activated during different portions of a single wash path). A wash cycle executing the wash path can include any appropriate combination/permutation of subdividing, duplicating, reversing, and/or rearranging wash paths during various portions of the wash cycle. However, the wash cycle can otherwise suitably operate according to the wash path.

In an example: the sequence of wash points comprises a top wash subsequence and a side wash subsequence. In this example, washing the vehicle can include spraying fluid through a plurality of nozzles of the tool head while simultaneously traversing along the wash path. In this example, a central axis of each of the plurality of nozzles can define a smaller skew angle relative to vertical than horizontal at each wash point of the top wash subsequence, and the central axis of each of the plurality of nozzles can define a smaller skew angle relative to horizontal than vertical at each wash point of the side wash subsequence.

However, the vehicle can be otherwise suitably washed according to the wash path.

In variants, one or more portions of the wash path can be executed concurrently and/or simultaneously with generation of a granular vehicle model according to S200, wherein the one or more portions can be determined based on a coarse vehicle model (e.g., bounding box). In one example, the wash path can be determined by setting a height of the tool head at a distance above the bounding box according to a predetermined avoidance rule (e.g., set height to a maximum value, predetermined offset, etc.) and traversing the length of the vehicle twice (e.g., where the span of the tool head and/or span of a tool head spray pattern is at least half the width of the coarse vehicle model), such as with the elevation angle held constant with the tool head radiating substantially orthogonally from the Z-axis, directing the nozzles downward. The wash tool head can traverse a periphery of the coarse vehicle model (with the tool head directed inward, traversing the length with the base of the tool head at the left and right sides), a centerline of the coarse vehicle model (e.g., with the tool at opposing azimuthal angles for the respective passes; with the tool head in a left arrangement and a right arrangement; based on the length of the coarse vehicle model), and/or any other suitable trajectory. In a second example, the wash tool head can traverse a predetermined wash path during S200 (e.g., chemical agent dispersion sequence, pre-soak, etc.) in response to a determination that the coarse vehicle model satisfies a collision avoidance rule (e.g., bounded within the working volume, offset from the wash tool head by at least a predetermined clearance distance) and/or a coverage rule (e.g., width of the vehicle model is less than a predetermined value, length is within a predetermined range; projected area of the coarse vehicle model is spanned by a coverage area of the predetermined wash path, etc.).

Alternative embodiments implement the above methods and/or processing modules in non-transitory computer-readable media, storing computer-readable instructions. The instructions can be executed by computer-executable components integrated with the computer-readable medium and/or processing system. The computer-readable medium may include any suitable computer readable media such as RAMs, ROMs, flash memory, EEPROMs, optical devices (CD or DVD), hard drives, floppy drives, non-transitory computer readable media, or any suitable device. The computer-executable component can include a computing system and/or processing system (e.g., including one or more collocated or distributed, remote or local processors) connected to the non-transitory computer-readable medium, such as CPUs, GPUs, TPUS, microprocessors, or ASICs, but the instructions can alternatively or additionally be executed by any suitable dedicated hardware device.

Embodiments of the system and/or method can include every combination and permutation of the various system components and the various method processes, wherein one or more instances of the method and/or processes described herein can be performed asynchronously (e.g., sequentially), concurrently (e.g., in parallel), or in any other suitable order by and/or using one or more instances of the systems, elements, and/or entities described herein.

As a person skilled in the art will recognize from the previous detailed description and from the figures and claims, modifications and changes can be made to the preferred embodiments of the invention without departing from the scope of this invention defined in the following claims.

We claim:

1. A method for automated vehicle washing with a tool head, comprising:
with an imaging system, generating an imaging dataset for a vehicle defining a long axis;
generating a model of the vehicle based on the imaging dataset;
determining a sequence of wash points based on the model and a tool head span;
determining a tool head pose for each wash point which maximizes a wash score, wherein the wash score is computed based on an angle of incidence and a spray distance; and
generating a wash path for the sequence by interpolating the tool head pose between adjacent wash points of the sequence.

2. The method of claim 1, wherein generating the imaging dataset comprises translating the imaging system along the long axis of a vehicle, wherein the method further comprises: washing a vehicle using a 5-axis system to wash both top and sides of the vehicle using a set of spray nozzles of the tool head.

3. The method of claim 1, wherein the sequence of wash points comprises a top wash subsequence and a side wash subsequence, wherein washing the vehicle comprises: spraying fluid through a plurality of nozzles of the tool head while simultaneously traversing along the wash path, wherein a central axis of each of the plurality of nozzles defines a smaller skew angle relative to vertical than horizontal at each wash point of the top wash subsequence, wherein the central axis of each of the plurality of nozzles defines a smaller skew angle relative to horizontal than vertical at each wash point of the side wash subsequence.

4. The method of claim 1, wherein the wash path comprises a top wash path, wherein a vertical projection of the top wash path comprises a boustrophedonic pattern.

5. The method of claim 1, wherein the determining the sequence of wash points comprises:
determining a set of lateral wash passes based on a length of the model along the long axis of the vehicle and the span of the tool head, each lateral wash pass defining a plane at a fixed longitudinal position relative to the model;
for each lateral wash pass, determining a set of wash points spanning a width of the model in the plane of the lateral wash pass;
wherein determining the tool head pose for each wash point comprises:
for a wash point of each wash pass, determining a tool head elevation angle which minimizes a height adjustment based on the tool head elevation angle at the wash point; and
setting a tool head height for the wash point based on the tool head elevation angle and a model offset.

6. The method of Claim 5, wherein tool head height is constant for each wash point within the wash pass.

7. The method of Claim 5, for each wash pass, selecting between a forward and rearward azimuthal orientation of the tool head based on the tool elevation angles of the wash pass and an elevation range of motion of the tool head.

8. The method of claim 1, wherein the wash path comprises a plurality of side wash passes, each side wash pass encircling the model and vertically offset from adjacent side wash passes of the plurality based on a span of the tool head.

9. The method of claim 8, wherein each side wash pass inclusively bounds an interior region, the interior region spanning a vertical projection of each wash point of each side wash pass of the plurality lying above the interior region.

10. The method of claim 1, wherein the wash score is determined based on an angle of incidence of a normal vector of the tool head and the model.

11. The method of claim 10, wherein determining the pose of the tool head comprises:
computing the wash score for a plurality of tool head poses at each wash point and maximizing the wash score using a Monte-Carlo optimization.

12. The method of claim 11, wherein the wash score includes a penalty based on a required tool head acceleration along a trajectory spanning the nearest adjacent wash points of the sequence, where a magnitude of the penalty is weighted based on relative acceleration constraints among a plurality of actuation axes.

13. The method of claim 1, wherein the sequence of wash points comprises a first wash pass and a second wash pass which are offset by less than the tool head span.

14. The method of claim 13, wherein the first and second washes pass define opposing net rotations about a vertical axis of the tool head.

15. The method of claim 13, wherein the first and second wash passes define a first and a second horizontal plane, respectively, which are offset vertically.

16. The method of claim 13, wherein the first and second wash passes are lateral wash passes which are offset longitudinally along the long axis of the vehicle.

17. The method of claim 1, wherein generating the model comprises:
slicing the imaging dataset horizontally to generate a set of data slices, each data slice comprising a vehicle body dataset;
for each vehicle body dataset, generating a convex hull; and
generating a model using the convex hulls of each slice, comprising: removing overhangs within the model.

18. An automated vehicle washing method, comprising:
with an imaging system, generating an imaging dataset for a vehicle;
generating a model of the vehicle based on the imaging dataset, comprising:
slicing the imaging dataset horizontally to generate a set of data slices, each data slice comprising a vehicle body dataset;
for each vehicle body dataset, generating a convex hull spanning a projection of an upward adjacent data slice of the set; and
generating a model using the convex hulls of each slice;
determining a sequence of wash points based on the model and a tool head span; and
generating, for the tool head, a wash path spanning each wash point of the sequence.

19. The automated vehicle washing method of claim 18, wherein generating the model of the vehicle further comprises: subdividing the imaging dataset into the vehicle body dataset and a side-mirror dataset; wherein generating the model using the convex hull of each slice comprises:
generating a vehicle body model based on the vehicle body dataset;
generating a side-mirror model based on the side-mirror dataset; and
combining the vehicle body model and the side-mirror model into the model.

20. The automated vehicle washing method of claim 18, wherein generating the model using the convex hulls of each slice comprises:
generating the mesh using the convex hulls of each slice; and
thickening the mesh based on a minimum tool head clearance.

21. The automated vehicle washing method of claim 18, wherein generating an imaging dataset comprises transforming the imaging system along a long axis of the vehicle.

22. The automated vehicle washing method of claim 21, wherein imaging system comprises a lidar sensor mechanically coupled to a longitudinal actuation stage, the longitudinal actuation stage configured to transform the tool head and the lidar sensor along the long axis of the vehicle.
